(19) United States
(12) Patent Application Publication
(10) Pub. No.: US 2024/0344529 A1
(43) Pub. Date: Oct. 17, 2024

(54) ELEVATING APPARATUS, PUMP CARRYING-IN METHOD, PUMP PULLING-UP METHOD

(71) Applicant: EBARA CORPORATION, Tokyo (JP)

(72) Inventors: Shuichiro HONDA, Tokyo (JP); Tetsuji KASATANI, Tokyo (JP); Hayato IKEDA, Tokyo (JP); Mitsutaka IWAMI, Tokyo (JP)

(21) Appl. No.: 18/681,592

(22) PCT Filed: Aug. 9, 2022
(86) PCT No.: PCT/JP2022/030381

§ 371 Date: Feb. 6, 2024

(30) Foreign Application Priority Data
Aug. 17, 2021 (JP) 2021-132900

(51) Int. Cl. F04D 29/60; F04B 15/08; F04D 13/08

(52) U.S. Cl. CPC F04D 29/607; F04B 15/08; F04D 13/08; F04D 29/604; F04B 2015/0822

(57) ABSTRACT

An elevating apparatus that can eliminate a need for a permanently installed large hoist is provided. The elevating apparatus is used to elevate and lower a submersible pump in a pump column. The submersible pump is used for delivering liquefied gas. The elevating apparatus includes a cable including multiple split cables and multiple coupling links configured to detachably couple the multiple split cables to each other; and a take-up device coupled to the cable.

### TECHNICAL FIELD

The present invention relates to an elevating apparatus for elevating and lowering, in a pump column, a submersible pump for pressurizing liquefied gas, such as liquefied ammonia, liquefied natural gas (LNG), or liquid hydrogen. Furthermore, the present invention relates to a method of carrying a submersible pump into a pump column and a method of pulling up the submersible pump out of the pump column using such an elevating apparatus.

### BACKGROUND ART

Natural gas is widely used for thermal power generation and used as a raw material for chemicals. Furthermore, ammonia and hydrogen are expected to be energies that do not generate carbon dioxide that causes global warming. Applications of hydrogen as an energy include fuel cell and turbine power generation. Natural gas, ammonia, and hydrogen are in a gaseous state at normal temperature, and therefore natural gas, ammonia, and hydrogen are cooled and liquefied for their storage and transportation. Liquefied gas, such as liquefied natural gas (LNG), liquefied ammonia, and liquefied hydrogen, is temporarily stored in a liquefied-gas storage tank and then delivered to a power plant, factory, or the like by a pump.

FIG. 30 is a schematic diagram showing a conventional example of a liquefied-gas storage tank in which liquefied gas is stored and a pump for pumping up the liquefied gas. A pump 500 is installed in a vertical pump column 505 disposed in a liquefied-gas storage tank 501. The inside of the pump column 505 is filled with the liquefied gas, and the entire pump 500 is immersed in the liquefied gas. The pump 500 is thus a submersible pump that can operate in the liquefied gas. When the pump 500 is operated, the liquefied gas in the liquefied-gas storage tank 501 is sucked into the pump column 505, ascends in the pump column 505, and is discharged from the pump column 505 through a liquefied-gas discharge port 509.

The pump 500 is disposed in the pump column 505 with a cable 508 coupled to a top of the pump 500. An upper part of the cable 508 is wound around a cable holder 511 extending from a top cover 510 into the pump column 505 and held by the cable holder 511. A lower end of cable 508 is coupled to the pump 500. Accordingly, the cable 508 is also located within the pump column 505, as well as the pump 500.

The cable 508 is used to carry the pump 500 into the pump column 505 and to pull up the pump 500 out of the pump column 505. The cable 508 remains coupled to the pump 500, so that the need to couples the cable 508 to the pump 500 is eliminated when the pump 500 is raised. During operation of the pump 500, the cable 508 is immersed together with the pump 500 in the liquefied gas within the pump column 505. FIG. 31 is a diagram for explaining an operation of carrying the pump 500 into the pump column 505 and an operation of pulling up the pump 500 out of the pump column 505. An upper end of the cable 508 is coupled to a hoist 512 when the pump 500 is to be installed in the pump column 505 and when the pump 500 is to be elevated from the pump column 505 for the purpose of maintenance. The pump 500 is suspended by the cable 508 and is raised and lowered in the pump column 505 by the hoist 512.

### CITATION LIST

### Patent Literature

Patent document 1: Japanese Patent No. 3197645
Patent document 2: Japanese Patent No. 3198248
Patent document 3: Japanese Patent No. 3472379

### SUMMARY OF INVENTION

### Technical Problem

However, the pump column 505 for liquefied gas is typically very long in a vertical direction, and its length may be tens of meters. The cable 508 coupled to the pump 500 that has been installed on the bottom of the pump column 505 is also necessarily very long. As a result, the hoist 512 for winding the cable 508 must be a permanent large-sized hoist to be installed above the pump column 505. In order to install such large-sized hoist 512, a large frame capable of supporting the weight of the hoist is also required. Additionally, a facility may not have a space large enough to accommodate such large-sized hoist 512.

Installation and removal of the pump 500 to and from the pump column 505 are accompanied by a release of gas from the pump column 505 and entry of air into the pump column 505. Therefore, it is preferable to restrict an area of the opening at the top of the pump column 505 as small as possible. However, since the cable 508 passes through the top of the pump column 505, it is difficult to limit the opening.

Furthermore, in the final stage of installation of the pump 500 into the pump column 505, the cable 508 is unwound from the large hoist, and the unwound part of the cable 508 is wound around the cable holder 511 on the lower surface of the top cover 510, and the wound cable 508 on the cable holder 511 is disposed in the pump column 505. Since the upper opening of the pump column 505 remains open widely during these operations, gas is released from the pump column 505 and air enters the pump column 505. A similar situation occurs during an initial stage of the removal of the pump 500 from the pump column 50. A purge gas, such as an inert gas, may be supplied into the pump column 505 so as to prevent such gas release and air entry, but the large opening requires a large amount of purge gas.

Accordingly, the present invention provides an elevating apparatus capable of eliminating a need for providing a large-sized hoist. The present invention further provides a method of carrying a submersible pump into a pump column and a method of pulling up the submersible pump out of the pump column using such an elevating apparatus.

The present invention provides an elevating apparatus that can reduce an amount of purge gas used to prevent gas release from an opening at a top of a pump column and entry of air into the pump column when a pump is installed in the pump column and pulled out of the pump column. The present invention further provides a method of carrying a submersible pump into the pump column and a method of pulling up the submersible pump out of the pump column using such an elevating apparatus.

### Solution to Problem

In an embodiment, there is provided an elevating apparatus for elevating and lowering a submersible pump in a pump column, the submersible pump being used to deliver liquefied gas, the elevating apparatus comprising: a cable including multiple split cables and multiple coupling links configured to detachably couple the multiple split cables to each other; and a take-up device coupled to the cable.

In an embodiment, each of the multiple split cables has a length shorter than a height of the pump column in its longitudinal direction.

In an embodiment, the elevating apparatus further comprises a stopper having a shape that engages each of the multiple coupling links to prevent at least one of the multiple split cables from falling into the pump column.

In an embodiment, the stopper is larger than a hole formed in an upper lid covering an upper opening of a purge container coupled to the pump column.

In an embodiment, the elevating apparatus further comprises a support plate placed on an upper end of the pump column, the support plate having an opening having a shape that allows the multiple split cables and the multiple coupling links to pass therethrough while the shape does not allow the stopper to pass therethrough.

In an embodiment, the elevating apparatus further comprises a head plate placed on an upper end of the pump column, wherein the head plate has a closing member having a shape that covers an upper opening of the pump column, and a movable rod supported by the closing member, the movable rod is movable in a vertical direction relative to the closing member, and the movable rod has a lower end configured to be coupled to one of the multiple split cables.

In an embodiment, there is provided a method of carrying a submersible pump into a pump column, the submersible pump being used to deliver liquefied gas, the method comprising: coupling a cable to the submersible pump, the cable being coupled to a take-up device, the cable including at least one of multiple split cables that have been prepared in advance; and lowering the submersible pump in the pump column by the take-up device while adding remainder of the multiple split cables one by one to the cable.

In an embodiment, the multiple split cables are detachably coupled to each other by multiple coupling links.

In an embodiment, the method further comprises: accommodating the submersible pump in a purge container; and supplying a purge gas into the purge container to expose the submersible pump to the purge gas.

In an embodiment, the method further comprises: accommodating a newly added split cable in the purge container; and supplying the purge gas into the purge container to expose the newly added split cable to the purge gas.

In an embodiment, at least one of the multiple split cables and the submersible pump are accommodated in the purge container, and the purge gas is supplied into the purge container to expose the at least one of the multiple split cables and the submersible pump to the purge gas.

In an embodiment, the liquefied gas comprises liquid hydrogen, and at least a part of the purge gas comprises a gas composed of a component having a boiling point equal to or lower than a boiling point of hydrogen.

In an embodiment, the purge gas comprises hydrogen gas.

In an embodiment, the method further comprises coupling the multiple split cables located in the pump column to a head plate, wherein the head plate has a closing member having a shape that covers an upper opening of the pump column, and a movable rod supported by the closing member, the movable rod is movable in a vertical direction relative to the closing member, and the movable rod has a lower end coupled to one of the multiple split cables.

In an embodiment, there is provided a method of pulling up a submersible pump out of a pump column, the submersible pump being used to deliver liquefied gas, the method comprising: coupling a cable to the submersible pump, the cable being coupled to a take-up device, the cable including multiple split cables; and elevating the submersible pump from the pump column by the take-up device while removing the multiple split cables one by one from the cable.

In an embodiment, the multiple split cables are detachably coupled to each other by multiple coupling links.

In an embodiment, the method further comprises: before removing one of the multiple split cables, accommodating the one of the multiple split cables in a purge container; and supplying a purge gas into the purge container to expose the one of the multiple split cables to the purge gas.

In an embodiment, the method further comprises: accommodating the submersible pump in the purge container; and supplying the purge gas into the purge container to expose the submersible pump to the purge gas.

In an embodiment, the liquefied gas comprises liquid hydrogen, and at least a part of the purge gas comprises a gas composed of a component having a boiling point equal to or lower than a boiling point of hydrogen.

In an embodiment, the purge gas comprises hydrogen gas.

### Advantageous Effects of Invention

According to the invention, the multiple split cables are used. The submersible pump can be carried into the pump column by adding the multiple split cables one by one. Furthermore, the submersible pump can be raised from the pump column while removing the multiple split cables one by one. These split cables themselves do not need to be wound on a hoist. Therefore, a transportable hoist, a chain block, or other small hoist can be used. Therefore, the use of the multiple split cables can eliminate the need for an installation of a permanent large-sized hoist.

According to the present invention, it is not necessary to conduct the operation of winding the cable 508 around the cable holder 511 and the operation of unwinding the cable 508 from the cable holder 511 as shown in FIG. 30. Therefore, a time of opening the upper portion of the pump column can be shortened. As a result, the present invention can reduce an amount of purge gas that is used to prevent gas release from an opening at the top of the pump column and entry of air into the pump column.

### BRIEF DESCRIPTION OF DRAWINGS

FIG. 1 is a schematic diagram for explaining an operation of carrying a submersible pump into a pump column;

FIG. 2 is a perspective view showing a support plate and a stopper;

FIG. 3 is a perspective view showing a modification of the support plate shown in FIG. 2;

FIG. 4 is a perspective view showing another modification of the support plate shown in FIG. 2;

FIG. 5 is a side view showing a head plate;

FIG. 6 is a diagram illustrating an embodiment of carrying the submersible pump into the pump column;

FIG. 7 is a diagram illustrating an embodiment of carrying the submersible pump into the pump column;

FIG. 8 is a diagram illustrating an embodiment of carrying the submersible pump into the pump column;

FIG. 9 is a diagram illustrating an embodiment of pulling up the submersible pump out of the pump column;

FIG. 10 is a diagram illustrating an embodiment of pulling up the submersible pump out of the pump column;

FIG. 11 is a diagram illustrating an embodiment of carrying the submersible pump into the pump column;

FIG. 12 is a cross-sectional view of an embodiment of a purge container;

FIG. 13 is a schematic diagram showing the purge container coupled to the upper portion of the pump column;

FIG. 14 is a perspective view showing a baffle plate;

FIG. 15 is a diagram illustrating an embodiment of performing a dry-up operation for the submersible pump using the purge container;

FIG. 16 is a diagram illustrating an embodiment of performing the dry-up operation for the submersible pump using the purge container;

FIG. 17 is a diagram illustrating an embodiment of performing the dry-up operation for the submersible pump using the purge container;

FIG. 18 is a diagram illustrating an embodiment of performing the dry-up operation for the submersible pump using the purge container;

FIG. 19 is a diagram illustrating an embodiment of performing the dry-up operation for the submersible pump using the purge container;

FIG. 20 is a diagram illustrating an embodiment of performing the hot-up operation for the submersible pump using the purge container;

FIG. 21 is a diagram illustrating an embodiment of performing the hot-up operation for the submersible pump using the purge container;

FIG. 22 is a diagram illustrating an embodiment of performing the hot-up operation for the submersible pump using the purge container;

FIG. 23 is a diagram illustrating an embodiment of performing the hot-up operation for the submersible pump using the purge container;

FIG. 24 is a diagram illustrating an embodiment of performing the hot-up operation for the submersible pump using the purge container;

FIG. 25 is a cross-sectional view showing another embodiment of the purge container;

FIG. 26 schematic diagram showing the purge container coupled to the upper portion of the pump column;

FIG. 27A is a diagram illustrating an embodiment of performing the dry-up operation for both the submersible pump and one or more split cables simultaneously;

FIG. 27B is a diagram illustrating an embodiment of performing the dry-up operation for both the submersible pump and one or more split cables simultaneously;

FIG. 28A is a diagram illustrating an embodiment of performing the dry-up operation for both the submersible pump and one or more split cables simultaneously;

FIG. 28B is a diagram illustrating an embodiment of performing the dry-up operation for both the submersible pump and one or more split cables simultaneously;

FIG. 29 is a perspective view showing yet another embodiment of the purge container;

FIG. 30 is a schematic diagram showing a conventional example of a liquefied-gas storage tank in which liquefied gas is stored and a pump for pumping up the liquefied gas; and

FIG. 31 is a diagram illustrating a conventional operation of carrying a pump into a pump column and a conventional operation of pulling up the pump out of the pump column.

### DESCRIPTION OF EMBODIMENTS

Hereinafter, embodiments of the present invention will be described with reference to the drawings.

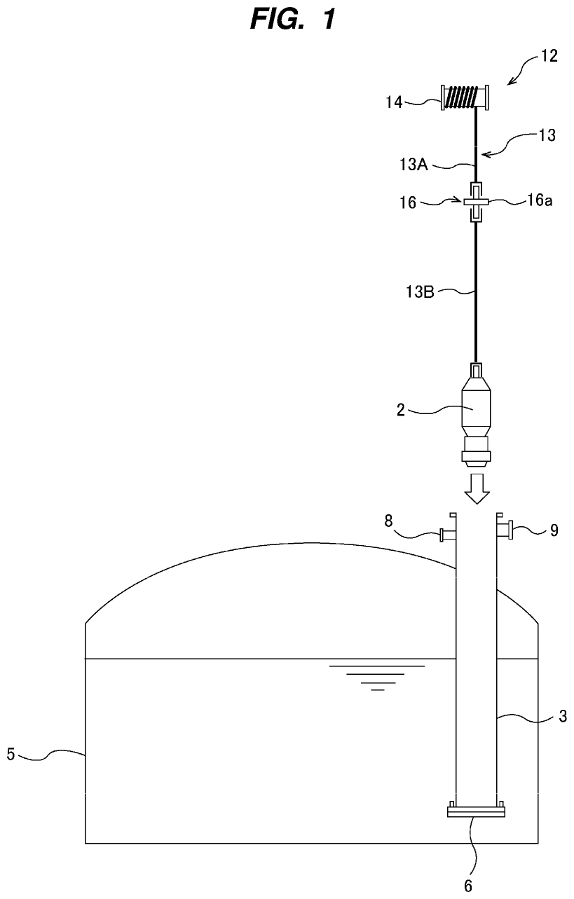

FIG. 1 is a schematic diagram for explaining an operation of carrying a submersible pump into a pump column. As shown in FIG. 1, a pump column 3 is installed in a liquefied-gas storage tank 5 in which liquefied gas is stored. Examples of liquefied gas include liquefied ammonia, liquid hydrogen, liquid nitrogen, liquefied natural gas, liquefied ethylene gas, liquefied petroleum gas, etc. The pump column 3 is a vertically extending hollow container, and its upper part protrudes upward from the liquefied-gas storage tank 5. A suction valve 6 is provided at a bottom of the pump column 3. A submersible pump 2 is installed on the bottom of the pump column 3. The structure of the suction valve 6 is not particularly limited. For example, the suction valve 6 may be of a type in which the suction valve 6 is opened by the weight of the submersible pump 2, or may be an actuator-driven valve (for example, an electric valve).

An elevating apparatus 12 is installed above the pump column 3. This elevating apparatus 12 is removably coupled to a frame (not shown). The submersible pump 2 is transported to a position above the pump column 3 by a transporting device (not shown), such as a crane. Furthermore, as shown in FIG. 1, the submersible pump 2 is coupled to a cable 13 of the elevating apparatus 12. The submersible pump 2 is elevated and lowered by the elevating apparatus 12. The elevating apparatus has a transportable take-up device 14, such as a hoist, a winch, or a chain block, which is configured to hoist the cable 13.

The cable 13 of the elevating apparatus 12 includes a trunk line 13A coupled to the take-up device 14 and multiple split cables 13B. In FIG. 1, one of the multiple split cables 13B prepared in advance is shown. The cable 13 further includes multiple coupling links 16. The split cable 13B is detachably coupled to the trunk line 13A by the coupling link 16. Furthermore, the multiple split cables 13B are detachably coupled to each other by the multiple coupling links 16. In FIG. 1, only one coupling link 16 is illustrated. Each coupling link 16 has a projecting portion 16a that extends laterally. The structure of each coupling link 16 is not particularly limited as long as each coupling link 16 can perform its intended function. Each coupling link 16 may be a metal member, such as a shackle.

A length of each of the multiple split cables 13B is shorter than a height of the pump column 3 in its longitudinal direction. As will be described later, the submersible pump 2 is lowered in the pump column 3 by the take-up device 14 of the elevating apparatus 12 while adding the multiple split cables 13B one by one to the cable 13.

Before the submersible pump 2 is put into the pump column 3, the liquefied gas is discharged from the pump column 3. Specifically, while an upper opening of the pump column 3 is closed, purge gas is supplied into the pump column 3 through a purge-gas introduction port 8, so that the liquefied gas is discharged from the pump column 3 through the suction valve 6 by the pressure of the purge gas.

After the discharge of the liquefied gas is completed, the submersible pump 2 is lowered (moved) into the pump column 3 by the elevating apparatus 12 until the submersible pump 2 is installed on the bottom of the pump column 3. When the suction valve 6 is opened, the liquefied gas in the liquefied-gas storage tank 5 flows into the pump column 3. The submersible pump 2 is operated while the entire submersible pump 2 is immersed in the liquefied gas, and pumps up the liquefied gas. The submersible pump 2 is a pump configured to be operable in liquid. The purge-gas introduction port 8 and a liquefied-gas discharge port 9 are provided on the upper portion of the pump column 3. The liquefied gas pumped up by the submersible pump 2 is discharged through the liquefied-gas discharge port 9.

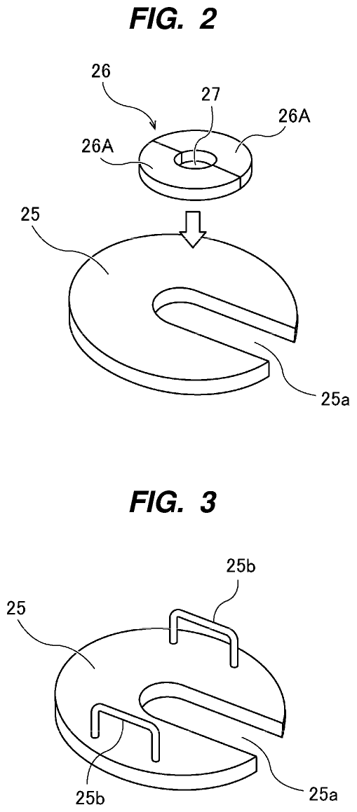

Next, an embodiment of an operation of carrying the submersible pump 2 into the pump column 3 using the elevating apparatus 12 will be described. The embodiment described below uses a support plate 25 and a stopper 26 shown in FIG. 2, and further uses a head plate 30 shown in FIG. 5. Both the support plate 25 and the head plate 30 are placed on an upper end of the pump column 3.

FIG. 2 is a perspective view showing the support plate 25 and the stopper 26. The stopper 26 is placed on the support plate 25. The support plate 25 has a shape that covers the upper opening of the pump column 3. The support plate 25 has an opening 25a that allows the split cable 13B of the elevating apparatus 12 to pass therethrough.

The opening 25a has a size that allows passage of the split cable 13B and the coupling link 16 of the elevating apparatus 12, but does not allow passage of the stopper 26. Specifically, a width of the stopper 26 is larger than a width of the opening 25a.

The stopper 26 has a shape that engages with the coupling link 16 (see FIG. 1). The stopper 26 of this embodiment has an opening 27 in its center and is divided into members 26A, 26A. The opening 27 allows the split cable 13B to pass therethrough, but does not allow the coupling link 16 to pass therethrough. When the split cable 13B moves downward through the opening 25a of the support plate 25, the projecting portion 16a (see FIG. 1) of the coupling link 16 coupled to the split cable 13B is engaged with the stopper 26 placed on the support plate 25. Therefore, the stopper 26 can prevent the split cable 13B from falling into the pump column 3.

In this embodiment, the stopper 26 is a split ring (e.g., two-split ring) constituting of a plurality of (typically two) members. However, the configurations of the coupling link 16 and the stopper 26 are not limited to this embodiment, as long as the coupling link 16 and the stopper 26 can provide their intended functions. For example, the stopper 26 may be a single member (e.g., a U-shaped member) having a gap extending outwardly from its center. Further, the coupling link 16 may be a shackle-like structure. In another example, the coupling link 16 may have a through-hole extending horizontally instead of having the projecting portion 16a, and the stopper 26 may be a rod member inserted into the through-hole. In this case also, the rod member does not pass through the opening 25a of the support plate 25, and can prevent the coupling link 16 and the split cable 13B from falling into the pump column 3.

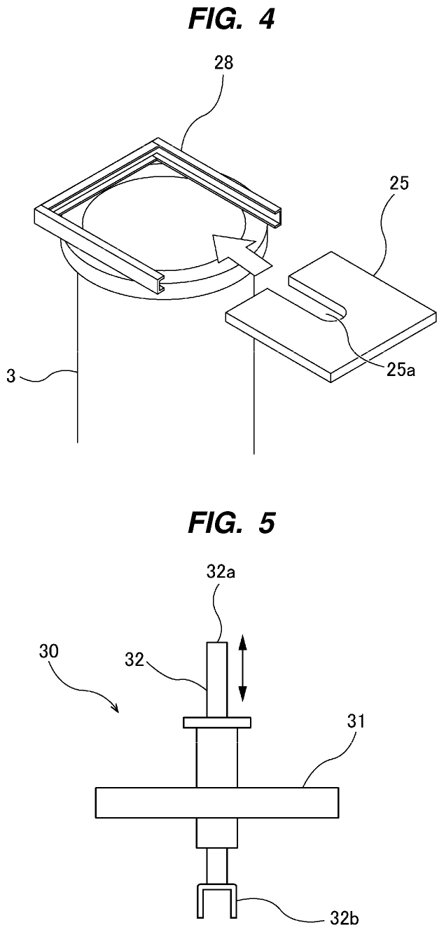

In the embodiment shown in FIG. 2, the opening 25a is formed of a cut opening extending outward from the center of the support plate 25, while the shape of the opening 25a is not limited to the embodiment shown in FIG. 2. The support plate 25 and the stopper 26 are used to temporarily support a load (or a weight) of the submersible pump 2 when the submersible pump 2 is carried into and pulled up from the pump column 3 as described below. As shown in FIG. 3, the support plate 25 may have two handles 25b on its upper surface. A worker can carry the support plate 25 by gripping these handles 25b. In one embodiment, as shown in FIG. 4, the support plate 25 may be configured to be attachable to a slide rail 28 fixed to the upper end of the pump column 3. Although the support plate 25 shown in FIG. 4 has a rectangular shape, the support plate 25 may have another shape as long as the support plate 25 can be mounted on the slide rail 28. Furthermore, although not shown, the support plate 25 may have a split structure having an opening 25a in its center.

FIG. 5 is a side view showing the head plate 30. The head plate 30 has a closing member 31 shaped to cover the upper opening of the pump column 3, and a movable rod 32 supported by the closing member 31. The movable rod 32 is vertically movable relative to the closing member 31. An upper end 32a of the movable rod 32 is configured to be connectable to the end of the split cable 13B, and a lower end 32b of the movable rod 32 is configured to be connectable to the coupling link 16. The head plate 30 is provided to close the upper opening of the pump column 3 so that the liquefied gas does not flow out from the upper opening of the pump column 3 while the submersible pump 2 is operating inside the pump column 3. The head plate 30 has a seal (not shown) that seals a gap between the movable rod 32 and the closing member 31 to prevent leakage of the liquefied gas through the head plate 30.

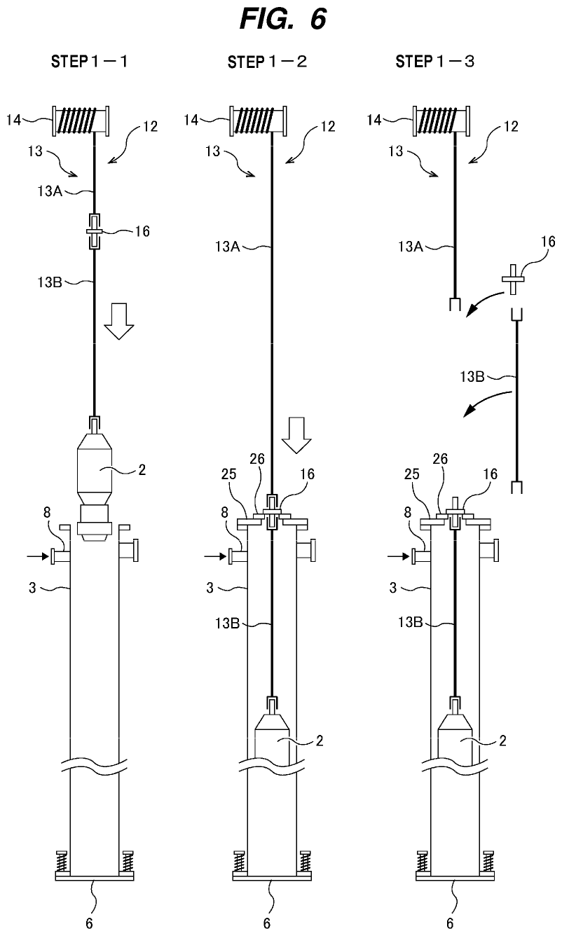

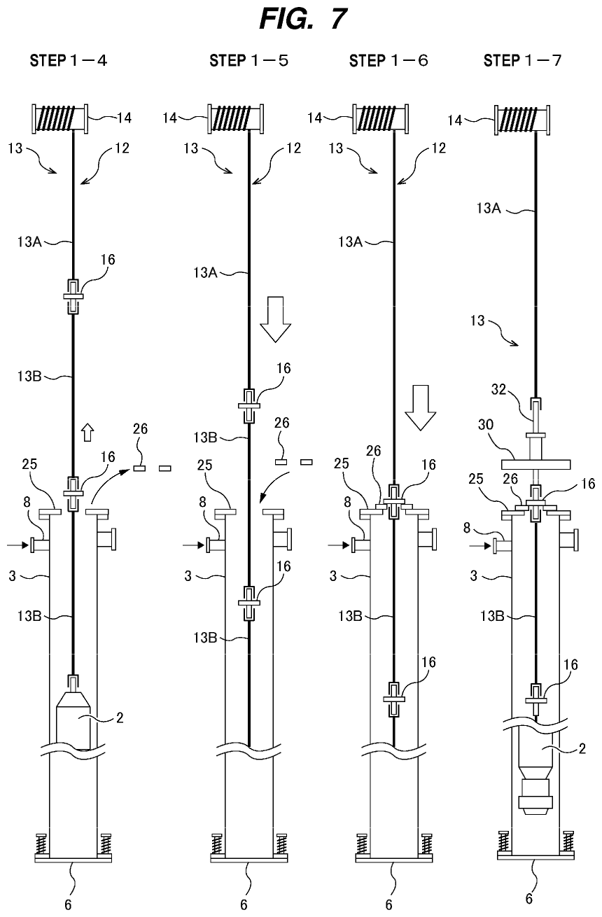

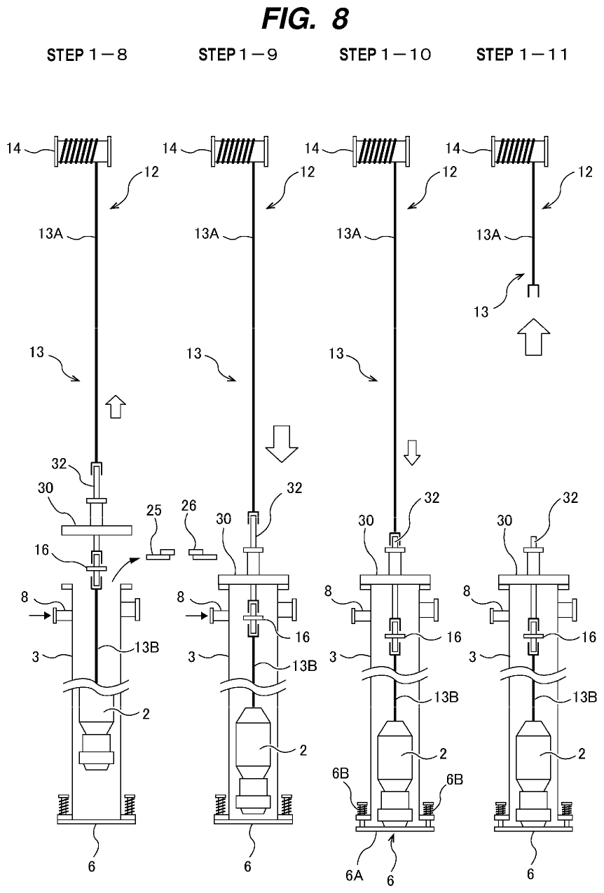

FIGS. 6 to 8 are diagrams each illustrating an embodiment of carrying the submersible pump 2 into the pump column 3. A series of operations shown in FIGS. 6 to 8 includes an operation of lowering the submersible pump 2 within the pump column 3 and an operation of adding the multiple split cables 13B one by one to the cable 13. The liquefied gas is discharged from the pump column 3 prior to the operations described below.

As shown in FIG. 6, in step 1-1, one of the multiple split cables 13B prepared in advance is coupled to the trunk line 13A, which is coupled to the take-up device 14, via the coupling link 16. The lower end of the cable 13B is coupled to the submersible pump 2. Then, the take-up device 14 lowers the submersible pump 2 and moves the submersible pump 2 into the pump column 3. In order to prevent ambient air from entering the pump column 3, a purge gas (e.g., including an inert gas and/or a gas having the same component as that of the liquefied gas) is supplied into the pump column 3 through the purge-gas introduction port 8. The supply of purge gas into the pump column 3 is basically continued in the following steps.

In step 1-2, when the coupling link 16 is located above the pump column 3, the support plate 25 is placed on the upper portion of the pump column 3, and the stopper 26 is placed on the support plate 25. The cable 13 and the submersible pump 2 are lowered by the take-up device 14 until the coupling link 16 engages (contacts) the stopper 26. The load (or weight) of submersible pump 2 is supported by the stopper 26 and the support plate 25 via the split cable 13B and the coupling link 16.

In step 1-3, another one of the multiple split cables 13B prepared in advance is added to the cable 13. More specifically, an upper end of the newly added split cable 13B is coupled to the trunk line 13A of the cable 13 via the coupling link 16, and a lower end of the newly added split cable 13B is coupled via the coupling link 16 to the upper end of the split cable 13B that has been added previously. At this point in time, the load of the submersible pump 2 is supported by the stopper 26 and the support plate 25.

In step 1-4, the cable 13 and the submersible pump 2 are slightly pulled up by the take-up device 14, and then the stopper 26 is removed from the support plate 25. The load of the submersible pump 2 is supported by the elevating apparatus 12.

In step 1-5, the take-up device 14 further lowers the cable 13 and the submersible pump 2. Before the uppermost coupling link 16 enters the pump column 3, the stopper 26 is again placed on the support plate 25.

In step 1-6, the cable 13 and the submersible pump 2 are lowered by the take-up device 14 until the coupling link 16 coupled to the upper end of the uppermost split cable 13B engages (contacts) the stopper 26. Once the coupling link 16 engages the stopper 26, the load of the submersible pump 2 is supported by the stopper 26 and the support plate 25.

Then, the same steps as the steps 1-3 to 1-6 are repeated while adding the remainder of the multiple split cables 13B one by one to the cable 13 until the submersible pump 2 is located near the bottom of the pump column 3.

In step 1-7, when the submersible pump 2 is located near the bottom of the pump column 3, the trunk line 13A of the cable 13 is coupled to the upper end of the movable rod 32 of the head plate 30, and the lower end of the movable rod 32 is coupled to the coupling link 16 engaging the stopper 26.

In step 1-8, the head plate 30, the split cables 13B, and the submersible pump 2 are slightly elevated by the take-up device 14, and the stopper 26 and the support plate 25 are removed from the pump column 3.

In step 1-9, the head plate 30, the split cables 13B, and the submersible pump 2 are lowered by the take-up device 14 until the head plate 30 contacts the upper end of the pump column 3. Then, the head plate 30 is fixed to the upper end of the pump column 3 by a head-plate fixing device (for example, bolts and nuts) not shown, so that the upper opening of the pump column 3 is sealed with the head plate 30. At this point, the submersible pump 2 in the pump column 3 is not in contact with the suction valve 6 located at the bottom of the pump column 3, but is located just above the suction valve 6. In step 1-10, the movable rod 32 of the head plate 30, the split cables 13B, and the submersible pump 2 are lowered by the take-up device 14 until the submersible pump 2 is placed on the suction valve 6. The suction valve 6 is opened by the weight of the submersible pump 2, and as a result, the liquefied gas in the liquefied-gas storage tank 5 (see FIG. 1) flows into the pump column 3. The suction valve 6 has a valve element 6A that covers the lower opening of the pump column 3, and springs 6B that bias the valve element 6A upward. When the submersible pump 2 is not placed on the valve element 6A, the valve element 6A is pressed against the lower end of the pump column 3 by the springs 6B to close the lower opening of the pump column 3. When the submersible pump 2 is placed on the valve element 6A, the weight of the submersible pump 2 causes the valve element 6A to move downward against the forces of the springs 6B, thereby opening the suction valve 6. The suction valve 6 may be an actuator-driven valve (e.g., an electrically operated valve).

In step 1-11, the trunk line 13A of the cable 13 is separated from the movable rod 32 of the head plate 30. In this way, the submersible pump 2 is installed in the pump column 3.

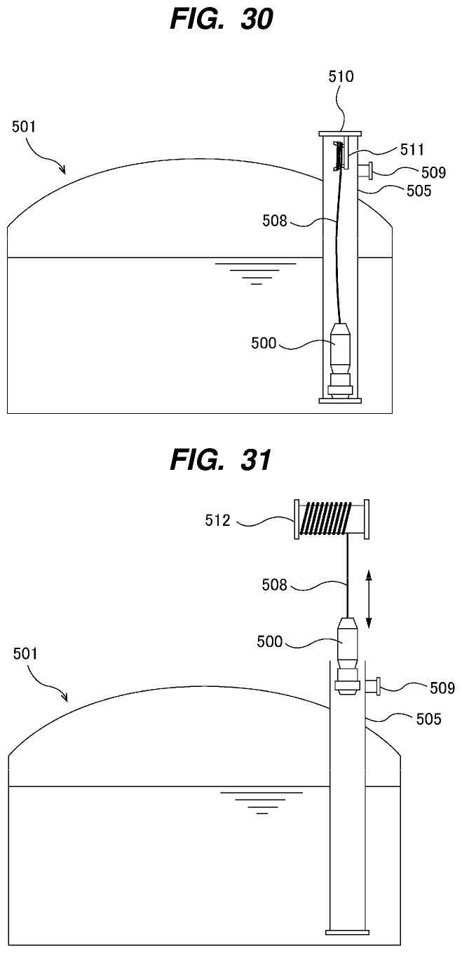

According to this embodiment, it is not necessary to conduct the operation of winding the cable 508 around the cable holder 511 as shown in FIG. 30, and a time during which the upper portion of the pump column 3 is open can be shortened. As a result, an amount of the purge gas used to prevent gas release from the pump column 3 and entry of air into the pump column 3 can be greatly reduced.

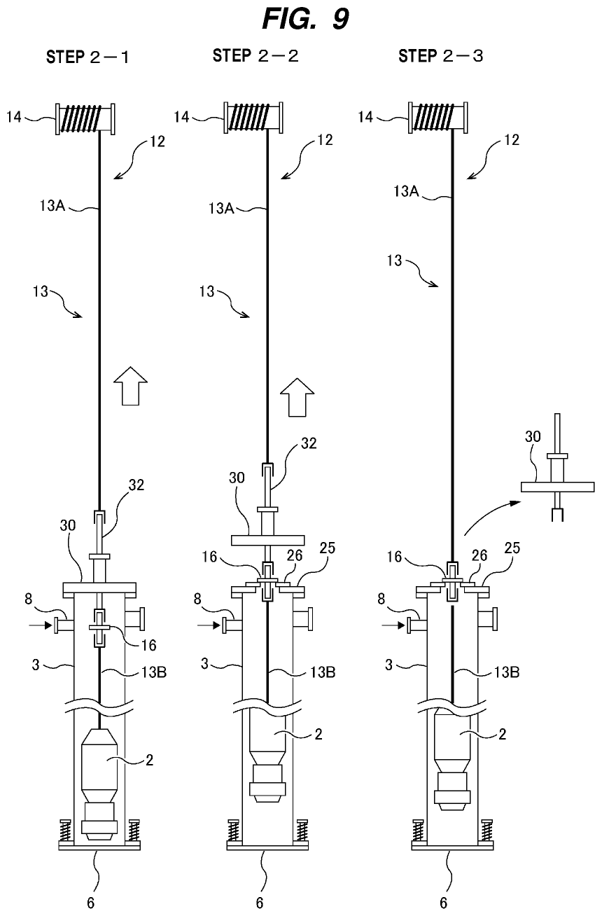

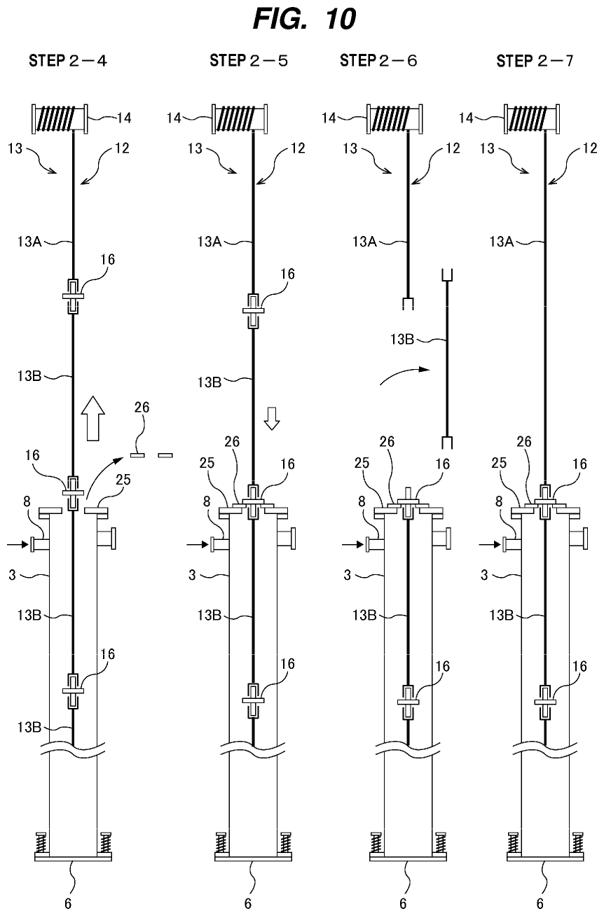

Next, an embodiment of an operation of pulling up the submersible pump 2 out of the pump column 3 will be described with reference to FIGS. 9 and 10. As will be described later, in this embodiment, the submersible pump 2 is pulled up from the pump column 3 by the take-up device 14 while removing the multiple split cables 13B one by one from the cable 13.

As shown in FIG. 9, in step 2-1, the trunk line 13A of the cable 13 is coupled to the movable rod 32 of the head plate 30. The movable rod 32, the multiple split cables 13B, and the submersible pump 2 are slight elevated by the take-up device 14 of the elevating apparatus 12, so that the submersible pump 2 is separated from the suction valve 6. Furthermore, the purge gas is supplied into the pump column 3 through the purge-gas introduction port 8, so that the liquefied gas is discharged from the pump column 3 through the suction valve 6 by the pressure of the purge gas. The suction valve 6 may be an actuator-driven valve (e.g., an electrically operated valve).

In step 2-2, after the liquefied gas is removed from the pump column 3, the head-plate fixing device (for example, bolts and nuts) not shown is removed. The head plate 30, the multiple split cables 13B, and the submersible pump 2 are then slightly elevated by the take-up device 14 to separate the head plate 30 from the pump column 3. Further, the support plate 25 is placed on the upper end of the pump column 3, and the stopper 26 is placed on the support plate 25. Thereafter, the head plate 30, the multiple split cables 13B, and the submersible pump 2 are lowered by the take-up device 14 until the coupling link 16 just above the stopper 26 engages (contacts) the stopper 26. The load (or weight) of the submersible pump 2 is supported by the stopper 26 and the support plate 25 via the multiple split cables 13B.

In order to prevent ambient air from entering the pump column 3, purge gas (e.g., including an inert gas and/or a gas having the same component as that of the liquefied gas) is supplied into the pump column 3 through the purge-gas introduction port 8. The supply of purge gas into the pump column 3 is basically continued in the following steps.

In step 2-3, the head plate 30 is removed from the cable 13. The trunk line 13A of the cable 13 is coupled to the coupling link 16 on the stopper 26.

In step 2-4, the multiple split cables 13B and the submersible pump 2 are pulled up by the take-up device 14 until the uppermost split cable 13B is located above the pump column 3. The stopper 26 is removed from the support plate 25 immediately after the operation of pulling up the multiple split cables 13B and the submersible pump 2 is started.

In step 2-5, the stopper 26 is put on the support plate 25 again. Further, the multiple split cables 13B and the submersible pump 2 are slightly lowered by the take-up device 14 until the coupling link 16 just above the stopper 26 engages (contacts) the stopper 26. The load (or weight) of the submersible pump 2 is supported by the stopper 26 and the support plate 25 via the multiple split cables 13B.

In step 2-6, the uppermost split cable 13B outside the pump column 3 is removed from the cable 13.

In step 2-7, the trunk line 13A of the cable 13 extending from the take-up device 14 is coupled to the coupling link 16 engaging the stopper 26. As a result, the trunk line 13A of the cable 13 is coupled to the submersible pump 2 via the split cables 13B.

Then, the same steps as the steps 2-4 to 2-7 are repeated while removing the multiple split cables 13B one by one, until the submersible pump 2 is elevated out of the pump column 3 by the take-up device 14.

According to this embodiment, the multiple split cables 13B are used. The submersible pump 2 can be carried into the pump column 3 while adding these split cables 13B one by one. Furthermore, the submersible pump 2 can be pulled up from the pump column 3 while removing the multiple split cables 13B one by one. Since these split cables 13B themselves do not need to be wound on the take-up device, a small take-up device, such as a transportable hoist or a chain block, can be used. Therefore, it is not necessary to install a permanent large-sized hoist.

Furthermore, according to this embodiment, the operation of unwinding the cable 508 from the cable holder 511 as shown in FIG. 30 is not required, and a time during which the upper portion of the pump column 3 is largely open can be shortened. As a result, an amount of the purge gas used to prevent gas release from the pump column 3 and entry of air into the pump column 3 can be greatly reduced.

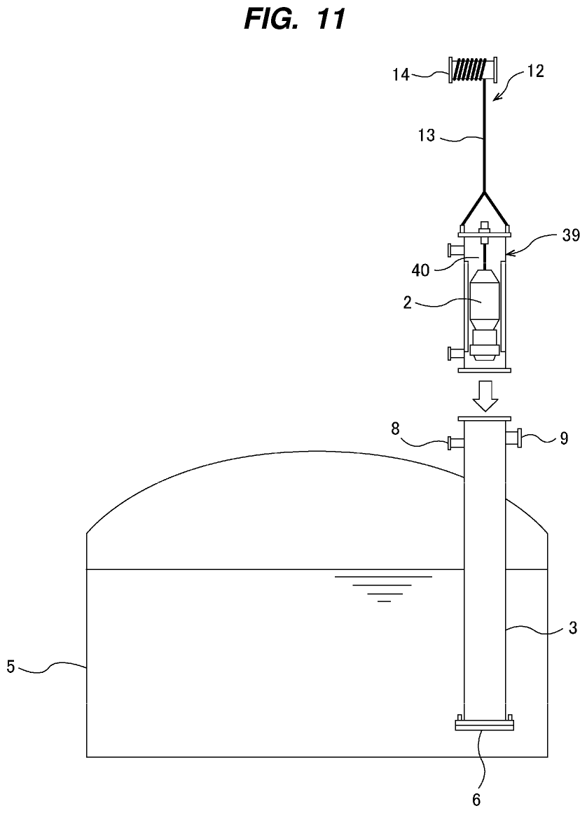

Next, another embodiment of the method of carrying the submersible pump 2 into the pump column 3 will be described with reference to FIG. 11. In the embodiment described below, before the submersible pump 2 is carried into the pump column 3, the submersible pump 2 and the split cables 13B are exposed to the purge gas in a purge container 39. The purge container 39 is a device for exposing the submersible pump 2 and the split cables 13B to the purge gas. The purge container 39 is detachably coupled to the pump column 3. The purge container 39 is a transportable type that can be transported together with the submersible pump 2 accommodated therein. In one embodiment, the purge container 39 may be fixed to the upper portion of the pump column 3.

The purge container 39 is conveyed together with the submersible pump 2 to a position above the pump column 3 by a transporting device (not shown) such as a crane. Furthermore, as shown in FIG. 11, the purge container 39 is coupled to the cable 13 of the elevating apparatus 12. The purge container 39 is elevated and lowered together with the submersible pump 2 by the elevating apparatus 12.

An interior space 40 of the purge container 39 is filled with the purge gas, and the submersible pump 2 is exposed to (or contacts) the purge gas. The purge container 39 is configured to be coupled to the upper portion of the pump column 3. The interior space 40 of the purge container 39 is filled with the purge gas before the purge container 39 is coupled to the upper portion of the pump column 3. Specifically, the purge gas is supplied into the purge container 39 while the submersible pump 2 is disposed in the purge container 39. With the interior space 40 of the purge container 39 filled with the purge gas, the purge container 39 is elevated or lowered together with the submersible pump 2 by the elevating apparatus 12.

The purge gas may be supplied into the purge container 39 at a location remote from the liquefied-gas storage tank 5, or the purge gas may be supplied into the purge container 39 after the purge container 39 is coupled to the cable 13 of the elevating apparatus 12 and before the purge container 39 is coupled to the upper portion of the pump column 3. Furthermore, in one embodiment, the purge gas may be supplied into the purge container 39 after the purge container 39 is coupled to the upper portion of the pump column 3 and before the submersible pump 2 is moved into the pump column 3 by the elevating apparatus 12. In either case, the submersible pump 2 is exposed to the purge gas within the purge container 39, so that air and moisture are expelled from the interior of the submersible pump 2 and its surfaces. In the following descriptions, a process of exposing the submersible pump 2 to the purge gas in the purge container 39 before the submersible pump 2 is carried into the pump column 3 is called dry-up operation.

The liquefied gas is discharged from the pump column 3 before the dry-up operation. Specifically, while the upper opening of the pump column 3 is closed, the purge gas is supplied into the pump column 3 through the purge-gas introduction port 8, so that the liquefied gas is discharged from the pump column 3 through the suction valve 6 by the pressure of the purge gas. In one embodiment, the discharge of the liquefied gas from the pump column 3 may be performed before the purge container 39 is transported together with the submersible pump 2 to a position above the pump column 3.

When the dry-up operation for the submersible pump 2 is completed, the submersible pump 2 is lowered (moved) from the purge container 39 into the pump column 3 by the elevating apparatus 12 and installed on the bottom of the pump column 3. When the suction valve 6 is opened, the liquefied gas in the liquefied-gas storage tank 5 flows into the pump column 3. The submersible pump 2 is operated while the entire submersible pump 2 is immersed in the liquefied gas, and pumps up the liquefied gas. The liquefied gas pumped up by the submersible pump 2 is discharged through the liquefied-gas discharge port 9.

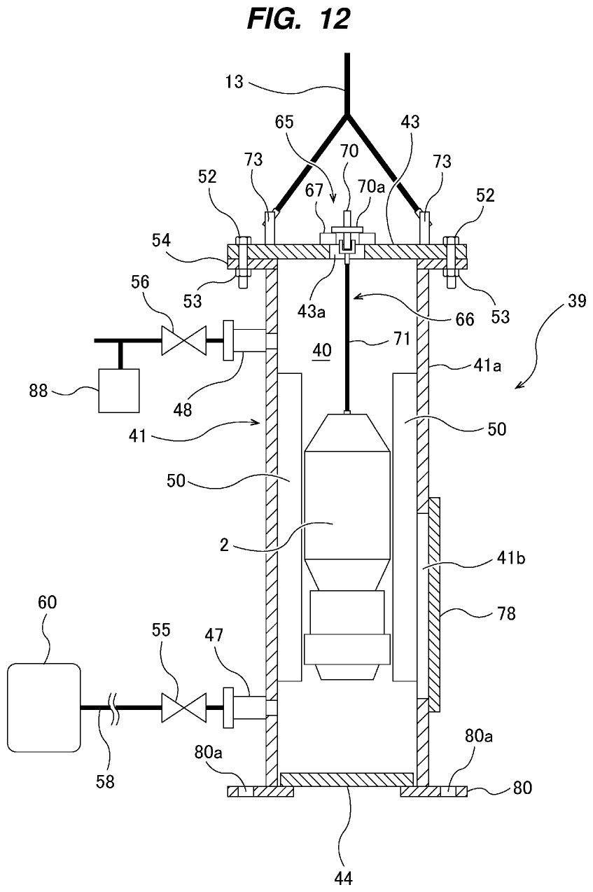

FIG. 12 is a cross-sectional view of an embodiment of the purge container 39. The purge container 39 includes a container body 41 having the interior space 40 for accommodating the submersible pump 2 therein, an upper lid 43 configured to cover an upper opening of the container body 41, a lower lid 44 configured to cover a lower opening of the container body 41, and a purge-gas inlet port 47 and a purge-gas outlet port 48 communicating with the interior space 40 of the container body 41. The container body 41 has a hollow structure. In this embodiment, the container body 41 has a cylindrical shape, but the shape of the container body 41 is not particularly limited. In one embodiment, the container body 41 may have a polygonal hollow structure, or may have other shape.

The purge container 39 includes pump guides 50 configured to suppress lateral shaking of the submersible pump 2. The pump guides 50 are fixed to an inner surface of the container body 41. The pump guides 50 are arranged around the submersible pump 2 disposed in the container body 41. The pump guides 50 are provided for the purpose of suppressing (or preventing) the horizontal shaking of the submersible pump 2 within the container body 41 when the purge container 39 with the submersible pump 2 disposed therein is transported by the transporting device, such as a crane. As long as such purpose can be achieved, multiple pump guides 50 may be provided, or a single pump guide 50 may be provided. The pump guide(s) 50 may be made of metal, elastic material, or a combination thereof. In one embodiment, the pump guide(s) 50 may be fixed to a side surface of the submersible pump 2, instead of the inner surface of the container body 41.

The purge container 39 includes a plurality of bolts 52 and a plurality of nuts 53 as fixing device for detachably fixing the upper lid 43 to the container body 41. The container body 41 has an upper flange 54 at the top of the container body 41. The plurality of bolts 52 extend through the upper lid 43 and the upper flange 54, and the plurality of nuts 53 are fastened to the plurality of bolts 52, respectively. When the nuts 53 are removed from the bolts 52, the upper lid 43 can be removed from the container body 41. In one embodiment, the fixing device that detachably fixes the upper lid 43 to the container body 41 may be one or more clamps, instead of the bolts 52 and the nuts 53.

The purge-gas inlet port 47 and the purge-gas outlet port 48 are fixed to a side wall 41a of the container body 41. More specifically, the purge-gas inlet port 47 is fixed to a lower part of the side wall 41a of the container body 41, and the purge-gas outlet port 48 is fixed to an upper part of the side wall 41a of the container body 41. In this embodiment, the purge-gas outlet port 48 is located higher than the purge-gas inlet port 47, while their arrangements are not limited to this embodiment. In one embodiment, the purge-gas inlet port 47 may be secured to the upper part of the side wall 41a of the container body 41, and the purge-gas outlet port 48 may be secured to the lower part of the side wall 41a of the container body 41. Alternatively, the purge-gas inlet port 47 and the purge-gas outlet port 48 may be located at the same height. Furthermore, in one embodiment, one of the purge-gas inlet port 47 and the purge-gas outlet port 48 may be fixed to the upper lid 43.

The purge container 39 further includes an inlet valve 55 coupled to the purge-gas inlet port 47, and an outlet valve 56 coupled to the purge-gas outlet port 48. A purge-gas supply line 58 is detachably coupled to the inlet valve 55. This purge-gas supply line 58 is coupled to a purge-gas supply source 60. When the purge gas is to be supplied into the purge container 39, the purge-gas supply line 58 is coupled to the inlet valve 55, and the inlet valve 55 is then opened. The purge gas is supplied from the purge-gas supply source 60 through the purge-gas supply line 58, the inlet valve 55, and the purge-gas inlet port 47 into the interior space 40 of the container body 41. While the purge gas is being supplied into the interior space 40, the outlet valve 56 is open and the air in the interior space 40 is replaced with the purge gas.

The purge gas used is gas composed of component (or element) having a boiling point lower than or equal to the boiling point of the liquefied gas to be pumped up by the submersible pump 2. This is because of preventing the purge gas from being liquefied when the purge gas contacts the liquefied gas or the ultra-low temperature submersible pump 2. Examples of purge gas include inert gas, such as nitrogen gas and helium gas. For example, when the liquefied gas to be pumped up by the submersible pump 2 is liquefied natural gas, nitrogen gas is used for the purge gas, since the nitrogen gas is composed of nitrogen having a boiling point (−196° C.) lower than the boiling point (−162° C.) of the liquefied natural gas. In another example, when the liquefied gas to be pumped up by the submersible pump 2 is liquid hydrogen, helium gas is used for the purge gas, since the helium gas is composed of helium having a boiling point (−269° C.) lower than the boiling point of hydrogen (−253° C.).

A part of the purge gas may contain a gas having the same component as that of the liquefied gas. If the purge-gas outlet port 48 is coupled to a gas treatment device, all of the purge gas may be gas of the same component as the liquefied gas. For example, if the liquefied gas is liquid hydrogen, a part or all of the purge gas may be hydrogen gas. Examples of the gas treatment device include gas incinerator (flaring device), chemical gas treatment device, gas adsorption device, and the like.

In one embodiment, the purge-gas supply source 60 described above is a nitrogen-gas supply source or a helium-gas supply source. Further, in one embodiment, the purge-gas supply source 60 may include purge-gas supply sources of different types, such as a nitrogen-gas supply source and a helium-gas supply source. In this case, the purge-gas supply sources may be selectively coupled to the purge-gas supply line 58. Further, in one embodiment, the purge-gas supply source 60 may include a supply source of gas composed of the same component as that of the liquefied gas. For example, if the liquefied gas is liquid hydrogen, the purge-gas supply source 60 may include a hydrogen-gas supply source.

Helium gas is generally more expensive than nitrogen gas. Nitrogen has a larger atomic weight than that of helium, and therefore has a higher drying effect. Therefore, nitrogen gas may be used as the purge gas at first, and helium gas may be used as the purge gas in a final stage. For example, nitrogen gas is supplied into the purge container 39 to replace the air in the interior space 40 of the container body 41 with nitrogen gas, and then helium gas is supplied into the purge container 39 to fill the interior space 40 of the container body 41 with helium gas.

As shown in FIG. 12, the purge container 39 further includes a pump suspension mechanism 65 detachably attached to the upper lid 43. The pump suspension mechanism 65 is configured to suspend the submersible pump 2 within the interior space 40 of the container body 41. The pump suspension mechanism 65 includes a coupling member 66 coupled to the submersible pump 2, and a stopper 67 engaged with the coupling member 66. More specifically, the coupling member 66 includes a coupling link 70 and a suspension cable 71 extending downward from the coupling link 70. The coupling link 70 has a projecting portion 70a projecting laterally. The stopper 67 is engaged with the projecting portion 70a of the coupling link 70. The coupling link 70 has the same shape and the same size as those of the coupling link 16 described in the previous embodiment. The stopper 67 has the same shape and the same size as those of the stopper 26 described in the previous embodiment.

The upper lid 43 has a hole 43a having a shape that does not allow passage of the stopper 67. A width of the hole 43a is larger than a width of the coupling link 70, so that the coupling link 70 is allowed to pass through the hole 43a. On the other hand, the width of the hole 43a is smaller than a width of the stopper 67, so that the stopper 67 is not allowed to pass through the hole 43a. The stopper 67 is placed on the upper surface of the upper lid 43 to prevent the coupling link 70 from falling into the container body 41. As can be seen from FIG. 12, the load (or weight) of the submersible pump 2 is applied to the upper lid 43 via the pump suspension mechanism 65 including the coupling link 70 and the stopper 67. In other words, the load (or weight) of the submersible pump 2 is supported by the upper lid 43.

The stopper 67 is detachably engaged with the coupling link 70. In this embodiment, the stopper 67 is a split ring (e.g., two-split ring) constituting of a plurality of (typically two) members. However, the configurations of the coupling link 70 and the stopper 67 are not limited to this embodiment. For example, the stopper 67 may be a single member (e.g., a U-shaped member) having a gap extending outwardly from its center. Further, the coupling link 70 may be a shackle-like structure. In another example, the coupling link 70 may have a through-hole extending horizontally instead of having the projecting portion 50a, and the stopper 67 may be a rod member inserted into the through-hole. In this case also, the rod member does not pass through the hole 43a of the upper lid 43, and the coupling link 70 can be prevented from falling into the container body 41.

The upper lid 43 has a plurality of coupling ports 73 to which the cable 13 of the elevating apparatus 12 is coupled. Each coupling port 73 is a structure having a hole through which the cable 13 can be inserted. A specific shape of each coupling port 53 is not particularly limited. The cable 13 is branched into a plurality of parts to have a plurality of distal ends. These distal ends are coupled to the coupling ports 73, respectively.

The lower lid 44 is removably placed on the bottom of the container body 41. The container body 41 has a lower flange 80 at a lower portion of the container body 41. The lower lid 44 is disposed on the lower flange 80. The lower lid 44 is a lid with no hole so that the purge gas filling the interior space 40 of the container body 41 does not leak through the lower lid 44. In one embodiment, the lower lid 44 may be constructed from a plurality of members. For example, the lower lid 44 may be a two-split lid having two members. The lower flange 80 has a plurality of through-holes 80a into which a plurality of bolts (not shown) are inserted, respectively.

The purge container 39 further includes a side lid 78 configured to close an opening 41b formed in the side wall 41a of the container body 41. The side lid 78 is removably fixed to the side wall 41a of the container body 41 by a fastening mechanism (for example, a plurality of screws) not shown. When the side lid 78 is removed, a worker can access the lower lid 44 in the container body 41 through the opening 41b and can remove the lower lid 44 from the container body 41. Similarly, a worker can bring the lower lid 44 into the container body 41 through the opening 41b and can place the lower lid 44 on the bottom of the container body 41 (i.e., on the lower flange 80).

The purge container 39 includes a purge index measuring device 88 communicating with the purge-gas outlet port 28. The purge index measuring device 88 is configured to measure an index value indicating a degree of dryness of the submersible pump 2 that has been exposed to the purge gas, and/or to measure an index value indicating the temperature of the submersible pump 2 that has been exposed to the purge gas. Examples of the purge index measuring device 88 include dew-point meter, thermometer, and a combination thereof. For example, the dew-point meter measures an amount of moisture in the purge gas that has flowed out of the interior space 40 of the container body 41. Whether or not the submersible pump 2 exposed to the purge gas has been sufficiently dried (i.e., whether or not the drying-up operation described below is sufficiently performed) can be determined based on a measured value of the amount of moisture. The thermometer measures the temperature of the purge gas that has flowed out of the interior space 40 of the container body 41. Whether or not the submersible pump 2 exposed to the purge gas has been sufficiently warmed (i.e., whether a hot-up operation described below is sufficiently performed) can be determined based on a measured value of the temperature of the purge gas that has contacted the submersible pump 2. The amount of moisture in the purge gas and the temperature of the purge gas are examples of index values for the drying-up operation and the hot-up operation for the submersible pump 2. The index values may be other physical quantities as long as they indicate the degree of dryness and the temperature of the submersible pump 2. In FIG. 12, the purge index measuring device 88 is coupled to the outlet valve 56, but the arrangement of the purge index measuring device 88 is not limited to the embodiment shown in FIG. 12, as long as the purge index measuring device 88 can fulfill its intended function.

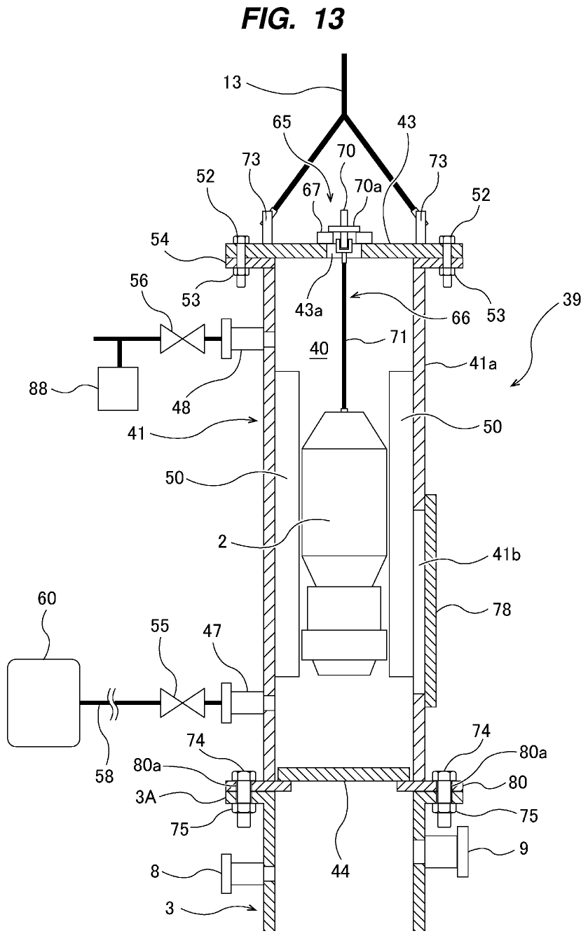

FIG. 13 is a schematic diagram showing the purge container 39 coupled to the upper portion of the pump column 3. As shown in FIG. 13, the purge container 39 with the submersible pump 2 housed therein is suspended from the cable 13 of the elevating apparatus 12, and is lowered by the elevating apparatus 12 until the lower flange 80 of the container body 41 is brought into contact with an upper flange 3A of the pump column 3. The lower flange 80 of the container body 41 is fixed to the upper flange 3A of the pump column 3 by bolts 74 and nuts 75 as a purge-container coupling mechanism. The bolts 74 extend in through-holes 80a formed in the lower flange 80 of the container body 41. In one embodiment, the purge-container coupling mechanism may be one or more clamps. The load of the submersible pump 2 is supported by the upper lid 43 and further supported by the pump column 3 via the container body 41.

In one embodiment, the submersible pump 2 may be placed on the lower lid 44. In this case, the pump suspension mechanism 65 including the coupling link 70 and the stopper 77 is not used, and the lower lid 44 is configured to support the submersible pump 2. More specifically, the lower lid 44 has sufficiently high mechanical strength to support the load of the submersible pump 2.

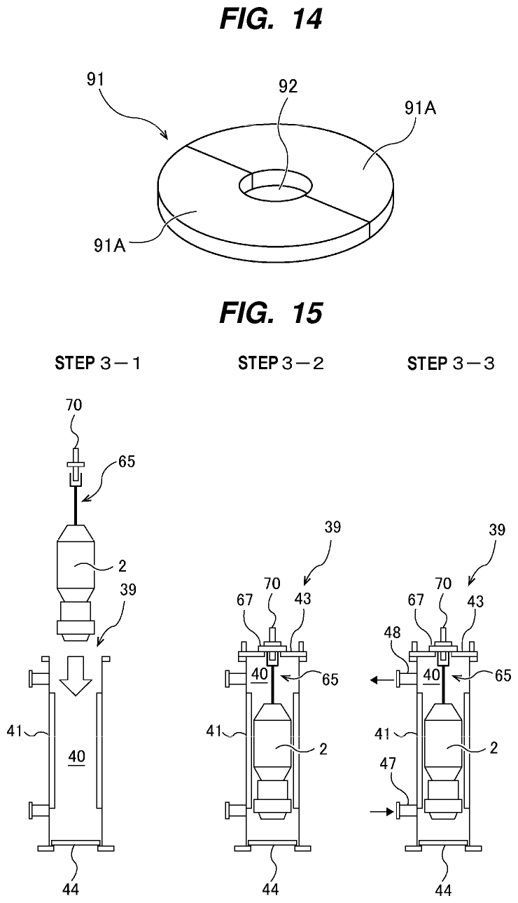

Next, an embodiment of the process of carrying the submersible pump 2 into the pump column 3 will be described. The embodiments described below use the support plate 25 and the stopper 26 shown in FIG. 2, the head plate 30 shown in FIG. 5, and a baffle plate 91 shown in FIG. 14. The baffle plate 91 described below is placed on the bottom of the container body 41 instead of the lower lid 44.

FIG. 14 is a perspective view showing the baffle plate 91. The baffle plate 91 has the same size and the same shape as the lower lid 44 (see FIG. 12), but differs from the lower lid 44 in that the baffle plate 91 has a hole 92 in its center and is divided into a plurality of plate pieces 91A. The hole 92 of the baffle plate 91 has a size that allows passage of the coupling link 16 (see FIG. 1) and the coupling link 70 (see FIG. 12). The baffle plate 91 is used to retain the purge gas that has been supplied into the interior space 40 of the container body 41 within the interior space 40.

FIGS. 15 to 19 are diagrams for explaining an embodiment of an operation of carrying the submersible pump 2 into the pump column 3 using the purge container shown in FIG. 12. A series of operations shown in FIGS. 15 to 19 includes a dry-up operation for drying the submersible pump 2 with purge gas, a dry-up operation for drying the multiple split cables 13B one by one with purge gas, and an operation of carrying the submersible pump 2 and the split cables 13B that has been dried into the pump column 3. The liquefied gas is discharged from the pump column 3 prior to the Operations of this embodiment, which will not be operations described below specifically described, are the same as those of the embodiments described with reference to FIGS. 6 to 8, and their repetitive descriptions will be omitted.

As shown in FIG. 15, in step 3-1, the lower lid 44 is placed on the bottom of the container body 41 of the purge container 39. With the upper lid 43 removed, the submersible pump 2 is disposed in the interior space 40 of the container body 41 of the purge container 39. The submersible pump 2 is moved into the purge container 39 by a transporting device (for example, a crane) which is not shown in the drawings.

In step 3-2, the upper lid 43 is attached to the upper portion of the container body 41 when the submersible pump 2 is located within the interior space 40 of the container body 41. The load (or weight) of the submersible pump 2 is supported by the upper lid 43 via the pump suspension mechanism 65 including the coupling link 70 and the stopper 67 (see FIG. 12). The upper lid 43 is firmly fixed to the container body 41 by the bolts 52 and the nuts 53 (see FIG. 12) as the fixing device.

In step 3-3, when the upper opening of the container body 41 is covered with the upper lid 43 and the lower opening of the container body 41 is covered with the lower lid 44, the purge gas (including, for example, an inert gas and/or a gas having the same component as that of the liquefied gas) is supplied through the purge-gas inlet port 47 into the interior space 40 of the container body 41 containing the submersible pump 2 therein to fill the interior space 40 with the purge gas. The purge gas is exhausted from the interior space 40 through the purge-gas outlet port 48. The purge gas expels air and moisture out of the submersible pump 2, and the submersible pump 2 is dried up.

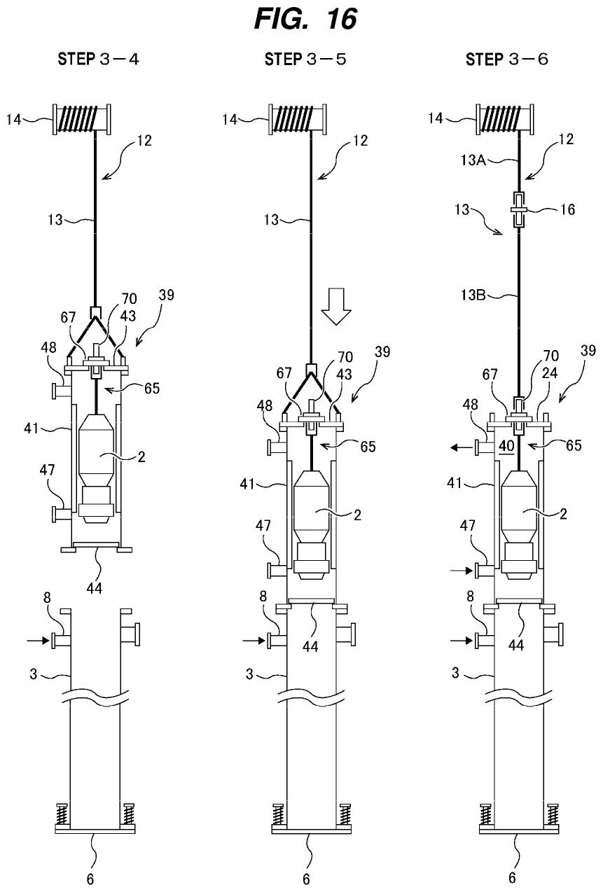

As shown in FIG. 16, in step 3-4, the purge container 39 filled with the purge gas is conveyed together with the submersible pump 2 to a position above the pump column 3 by a transporting device (for example, a crane) not shown. The cable 13 of the elevating apparatus 12 is coupled to the upper lid 43. The purge container 39 in which the submersible pump 2 is accommodated is suspended by the elevating apparatus 12. In order to prevent ambient air from entering the pump column 3, the purge gas (e.g., including an inert gas and/or a gas having the same component as that of the liquefied gas) is supplied into the pump column 3 through the purge-gas introduction port 8. The supply of the purge gas into the pump column 3 is basically continued in the following steps.

In step 3-5, the purge container 39 and the submersible pump 2 are lowered by the elevating apparatus 12, and the purge container 39 is coupled to the upper portion of the pump column 3. Specifically, as described with reference to FIG. 13, the lower flange 80 of the container body 41 is fixed to the upper flange 3A of the pump column 3 by the bolts 74 and the nuts 75 (see FIG. 13) which are the purge-container coupling mechanism. The load (or weight) of the submersible pump 2 is supported by the pump column 3 via the upper lid 43 and the container body 41.

In step 3-6, the purge gas (e.g., including an inert gas and/or a gas composed of the same component as that of the liquefied gas) is supplied through the purge-gas inlet port 47 into the interior space 40 of the container body 41, and the purge gas is exhausted from the interior space 40 through the purge-gas outlet port 48. At the same time, the purge gas flows out through minute gaps other than the purge-gas outlet port 48 of the purge container 39. Such purge gas flow can prevent ambient air from flowing into the interior space 40.

Before or after the supply of the purge gas is started, the cable 13 is disconnected from the upper lid 43. Furthermore, one of the multiple split cables 13B prepared in advance is added to the cable 13. More specifically, the upper end of the split cable 13B is coupled to the trunk line 13A of the cable 13 coupled to the take-up device 14 via the coupling link 16, and the lower end of the split cable 13B is coupled to the submersible pump 2 via the pump suspension mechanism 65 including the coupling link 70.

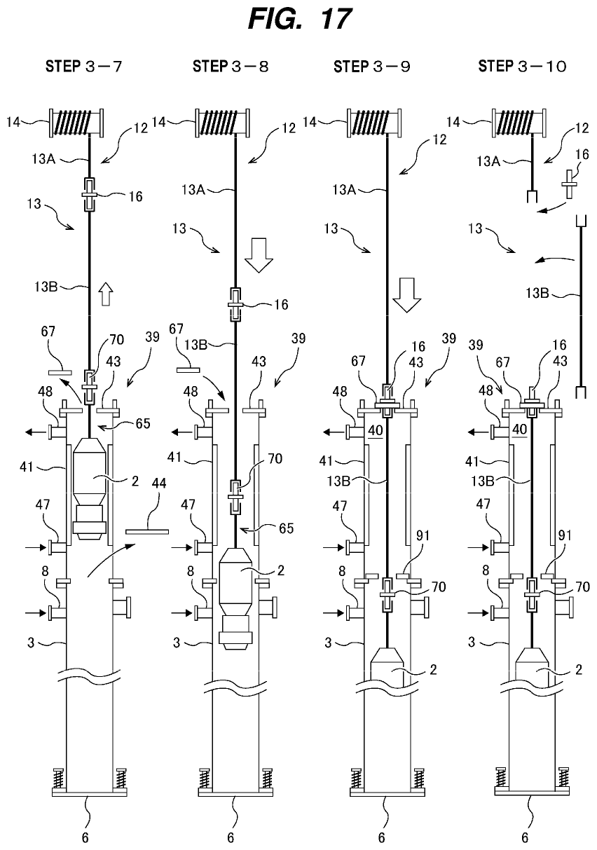

As shown in FIG. 17, in step 3-7, the pump suspension mechanism 65 and the submersible pump 2 are slightly elevated by the elevating apparatus 12, and then the stopper 67 is removed from the upper lid 43. The load of the submersible pump 2 is supported by the elevating apparatus 12. Furthermore, the lower lid 44 is removed from the container body 41.

In step 3-8, the submersible pump 2 is lowered by the elevating apparatus 12 until the submersible pump 2 is moved from the purge container 39 into the pump column 3, and the split cable 13B is moved into the interior space 40 of the container body 41. Before the uppermost coupling link 16 enters the pump column 3, the stopper 67 is placed on the upper lid 43 again.

In step 3-9, the submersible pump 2 is lowered by the elevating apparatus 12 until the coupling link 16 coupled to the upper end of the split cable 13B engages (contacts) the stopper 67. When the coupling link 16 coupled to the upper end of the split cable 13B engages the stopper 67, the load of the submersible pump 2 is supported by the upper lid 43. The baffle plate 91 (see FIG. 14 for details) is placed on the bottom of the container body 41. The baffle plate 91 is provided to keep the purge gas that has been supplied into the interior space 40 of the container body 41 within the interior space 40 while allowing the split cable 13B to pass through the baffle plate 91.

The split cable 13B has a length substantially equal to a longitudinal length of the container body 41, and the split cable 13B is substantially located inside the container body 41. Since the interior space 40 of the container body 41 is filled with the purge gas, the split cable 13B is exposed to the purge gas. As a result, the air and moisture entrained by the split cable 13B are removed from the split cable 13B by the purge gas, so that the split cable 13B is dried (degassed). This process is the dry-up operation for the split cable 13B.

In step 3-10, another one of the multiple split cables 13B prepared in advance is added to the cable 13. More specifically, an upper end of the newly added split cable 13B is coupled to the trunk line 13A of the cable 13 via the coupling link 16, and a lower end of the newly added split cable 13B is coupled via the coupling link 16 to the upper end of the split cable 13B that has been added previously. At this point in time, the load of the submersible pump 2 is supported by the upper lid 43.

The steps 3-7 to 3-10 are repeated with the baffle plate 91 remaining inside the container body 41 while adding the remaining split cables 13B one by one, until the submersible pump 2 is located near the bottom of the pump column 3.

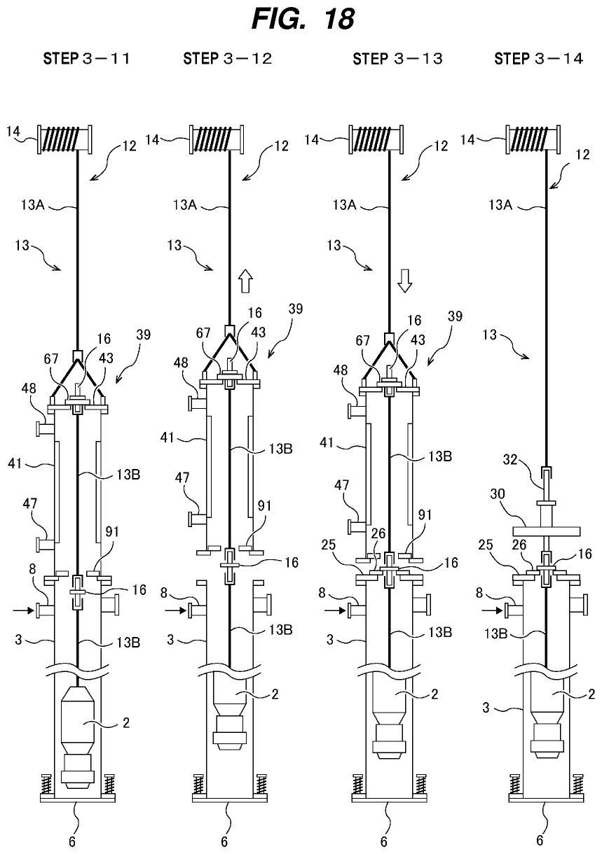

As shown in FIG. 18, in step 3-11, when the submersible pump 2 is located near the bottom of the pump column 3, the stopper 67 is placed on the upper lid 43 again, and the coupling link 16 coupled to the upper end of the uppermost split cable 13B is engaged with the stopper 67. The load of the submersible pump 2 is supported by the upper lid 43 via the multiple split cables 13B. Next, the trunk line 13A of the cable 13 suspended from the take-up device 14 of the elevating apparatus 12 is coupled to the upper lid 43. Further, the bolts 74 and nuts 75 (see FIG. 13), serving as the purge-container coupling mechanism that couple the container body 41 to the pump column 3, are removed.

In step 3-12, the purge container 39, the split cables 13B suspended down from the upper lid 43 of the purge container 39, and the submersible pump 2 coupled to the lowest split cable 13B are elevated slightly by the take-up device 14 of the elevating apparatus 12 to separate the purge container 39 from the pump column 3.

In step 3-13, the support plate 25 (see FIG. 2 for details) is placed on the upper end of the pump column 3, and the stopper 26 (see FIG. 2 for details) is placed on the support plate 25. Furthermore, the purge container 39, the multiple split cables 13B, and the submersible pump 2 are lowered by the take-up device 14 until the coupling link 16 directly below the purge container 39 engages the stopper 26. The load of the submersible pump 2 is supported by the stopper 26 and the support plate 25 via the multiple split cables 13B.

In step 3-14, the purge container 39 is removed from the cable 13 of the elevating apparatus 12 and is moved to another location by a transporting device (e.g., crane) not shown. Next, the head plate 30 (see FIG. 5 for details) is coupled to the cable 13 of the elevating apparatus 12. Specifically, the upper end of the movable rod 32 of the head plate 30 is coupled to the trunk line 13A of the cable 13 of the elevating apparatus 12. The lower end of the movable rod 32 is coupled to the upper end of the uppermost split cable 13B via the coupling link 16.

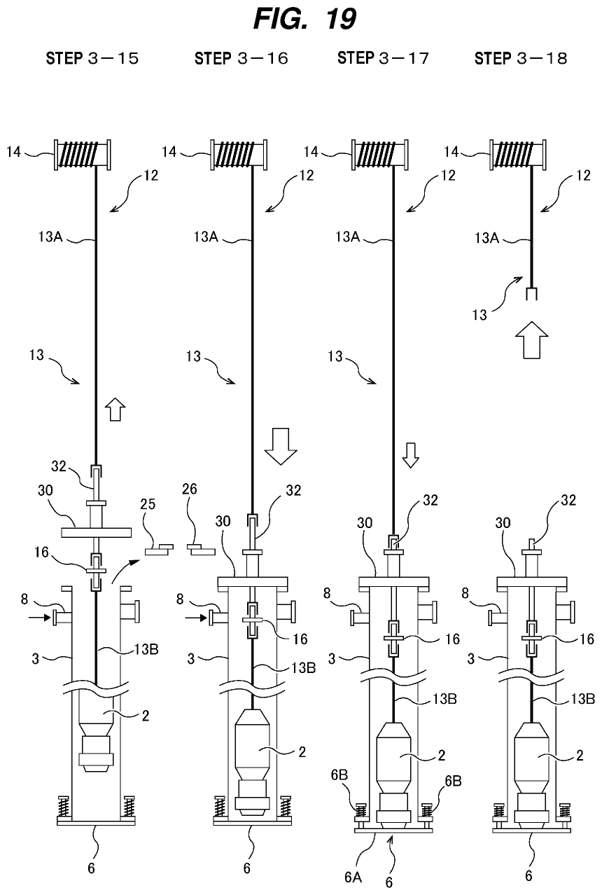

As shown in FIG. 19, in step 3-15, the head plate 30, the multiple split cables 13B, and the submersible pump 2 are slightly elevated by the take-up device 14, and the stopper 26 and the support plate 25 are removed from the pump column 3.

In step 3-16, the head plate 30, the multiple split cables 13B, and the submersible pump 2 are lowered by the take-up device 14 until the head plate 30 contacts the upper end of the pump column 3. Then, the head plate 30 is fixed to the upper end of the pump column 3 by the head-plate fixing device (for example, bolts and nuts) not shown. The upper opening of the pump column 3 is sealed with the head plate 30. At this point, the submersible pump 2 in the pump column 3 is not in contact with the suction valve 6 located at the bottom of the pump column 3, but is located just above the suction valve 6.

In step 3-17, the movable rod 32 of the head plate 30, the multiple split cables 13B, and the submersible pump 2 are lowered by the take-up device 14 until the submersible pump 2 is placed on the suction valve 6. The suction valve 6 is opened by the weight of the submersible pump 2, so that the liquefied gas in the liquefied-gas storage tank 5 (see FIG. 1) flows into the pump column 3. The suction valve 6 has the valve element 6A that covers the lower opening of the pump column 3 and the springs 6B that bias the valve element 6A upward. When the submersible pump 2 is not placed on the valve element 6A, the valve element 6A is pressed against the lower end of the pump column 3 by the springs 6B to close the lower opening of the pump column 3. When the submersible pump 2 is placed on the valve element 6A, the weight of the submersible pump 2 causes the valve element 6A to move downward against the forces of the springs 6B, thereby opening the suction valve 6.

In step 3-18, the cable 13 of the elevating apparatus 12 is disconnected from the movable rod 32 of the head plate 30.

In this way, the submersion pump 2 is dried up, the split cables 13B are dried up, and the submersion pump 2 is installed in the pump column 3.

According to this embodiment, the air and moisture entrained by the submersible pump 2 and the split cables 13B are removed by the purge gas, resulting in drying (degassing) of the submersible pump 2 and the split cables 13B. After the dry-up operation, the submersible pump 2 and the split cables 13B can be quickly moved into the pump column 3 while the purge gas exists around the submersible pump 2 and the split cables 13B. Therefore, the air and moisture are not entrained by the submersible pump 2 and the split cables 13B, and the intrusion of air and moisture into the pump column 3 can be prevented.

The dry-up operation in the step 3-3 is performed at a location away from the pump column 3. In one embodiment, after the submersible pump 2 is carried into the purge container 39, the purge container 39 is transported with the submersible pump 2 to the pump column 3, and after coupling of the purge container 39 to the pump column 3, the supply of the purge gas into the purge container 39 may be started. In other words, the dry-up operation of the submersible pump 2 may be started after the purge container 39 is coupled to the pump column 3. Alternatively, in one embodiment, after the submersible pump 2 is carried into the purge container 39 and the purge container 39 is transported with the submersible pump 2 to a position above the pump column 3, the supply of the purge gas into the purge container 39 may be started before the purge container 39 is coupled to the pump column 3.

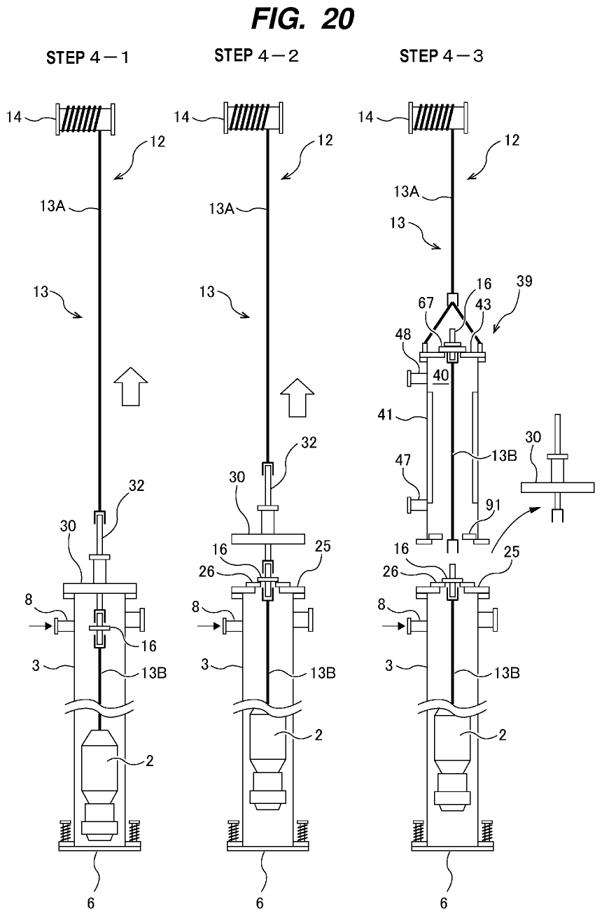

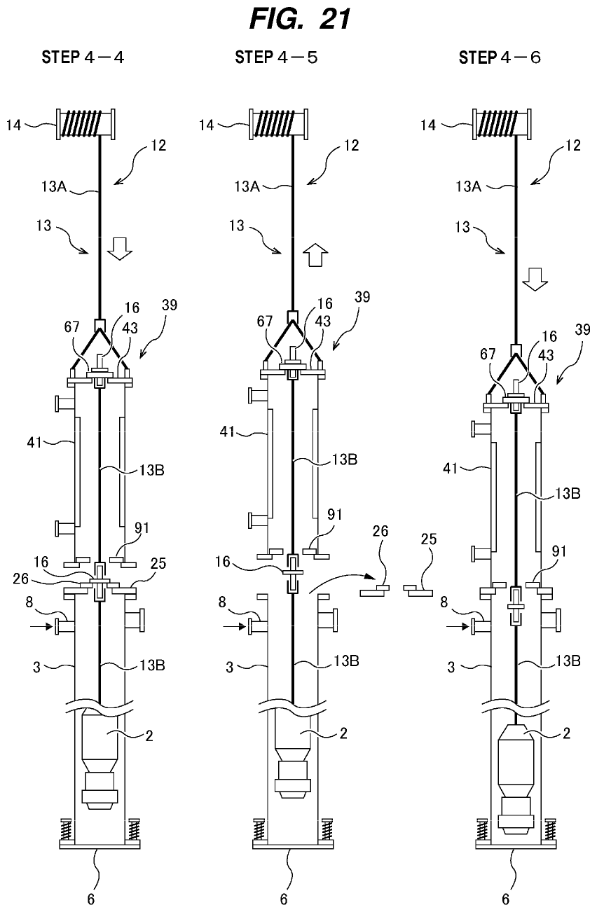

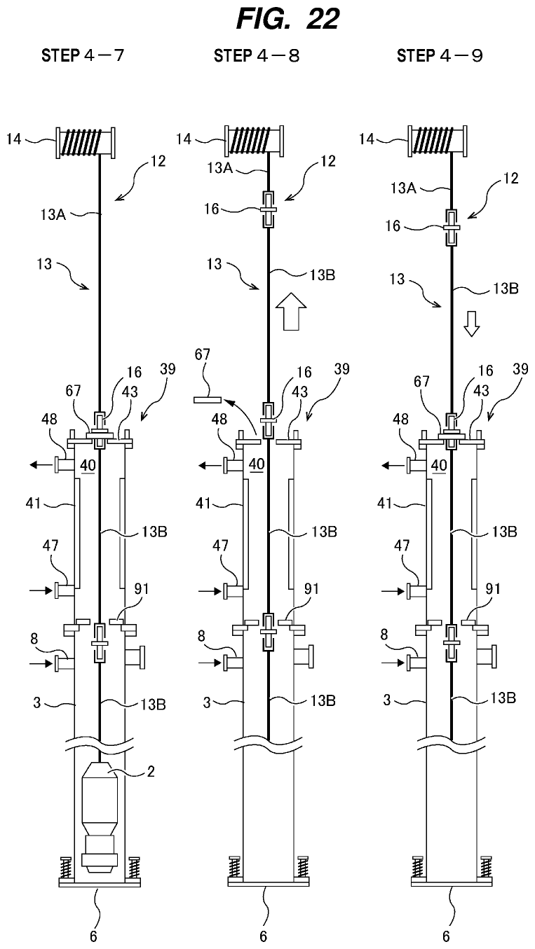

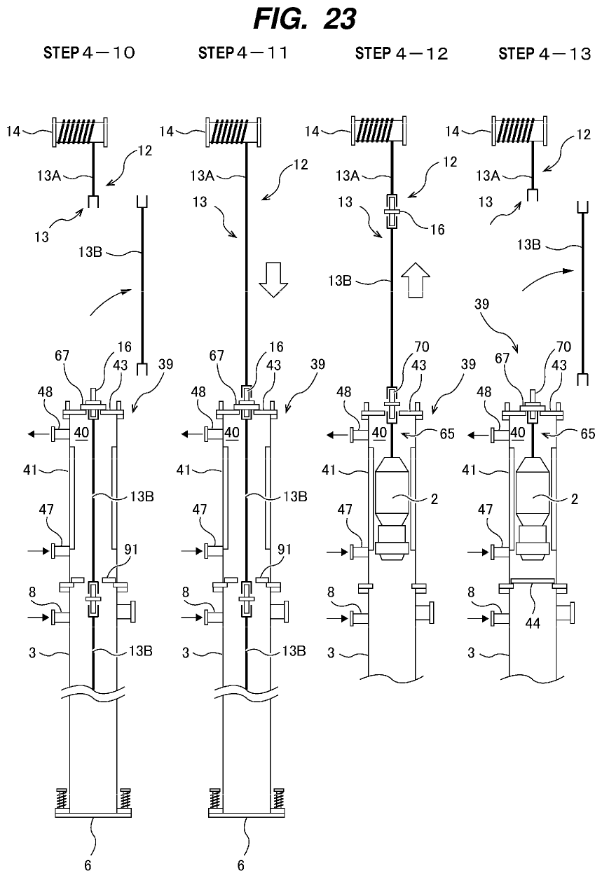

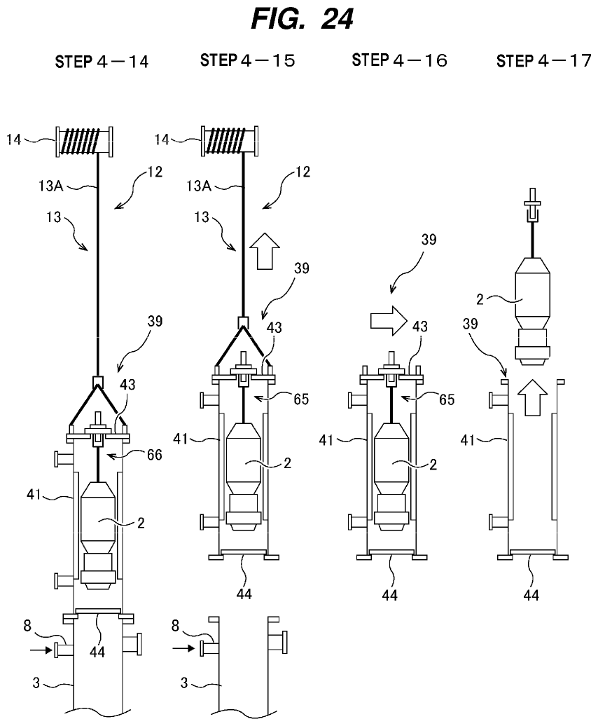

Next, an embodiment of removing the submersible pump 2 from the pump column 3, the hot-up operation for the submersible pump 2, and the hot-up operation for the split cables 13B will be described with reference to FIGS. 20 to 24. As will be described later, in this embodiment, the submersible pump 2 is pulled up from the pump column 3 by the take-up device 14 while removing the multiple split cables 13B one by one from the cable 13.

A series of operations shown in FIGS. 20 to 24 includes the hot-up operation of warming the ultra-low temperature split cables 13B one by one with the purge gas, the operation of pulling up the submersible pump 2 out of the pump column 3, and the hot-up operation of warming the ultra-low temperature submersible pump 2 with the purge gas. The split cables 13B and the submersible pump 2, both of which are subjected to the hot-up operation, have an ultra-low temperature, because the split cables 13B and the submersible pump 2 have been in contact with the liquified gas. Operations of this embodiment, which will not be specifically described, are the same as those of the embodiments described with reference to FIGS. 9 and 10.

As shown in FIG. 20, in step 4-1, the cable 13 of the elevating apparatus 12 is coupled to the movable rod 32 of the head plate 30. The movable rod 32, the multiple split cables 13B, and the submersible pump 2 are elevated slightly by the take-up device 14 of the elevating apparatus 12, so that the submersible pump 2 is separated away from the suction valve 6. Furthermore, the purge gas is supplied into the pump column 3 through the purge-gas introduction port 8, so that the liquefied gas is discharged from the pump column 3 through the suction valve 6 by the pressure of the purge gas.

In step 4-2, after the liquefied gas is removed from the pump column 3, the not-shown head-plate fixing device (for example, bolts and nuts) is removed. The head plate 30, the multiple split cables 13B, and the submersible pump 2 are then slightly elevated by the take-up device 14 to separate the head plate 30 from the pump column 3. Further, the support plate 25 is placed on the pump column 3, and the stopper 26 is placed on the support plate 25. Thereafter, the head plate 30, the multiple split cables 13B, and the submersible pump 2 are lowered by the take-up device 14 until the coupling link 16 just above the stopper 26 engages the stopper 26. The load (or weight) of the submersible pump 2 is supported by the stopper 26 and the support plate 25 via the multiple split cables 13B.

In step 4-3, the head plate 30 is removed from the cable 13, and the purge container 39 is instead coupled to the cable 13 of the elevating apparatus 12. The upper lid 43 is fixed to the container body 41 of the purge container 39, and the trunk line 13 A of the cable 13 of the elevating apparatus 12 is coupled to the upper lid 43. The baffle plate 91 (see FIG. 14 for details) is placed on the bottom of the container body 41. The stopper 67 is placed on the upper lid 43. One split cable 13B is suspended inside the container body 41 from the coupling link 16 engaging the stopper 67.

In step 4-4, the purge container 39 and the split cable 13B inside the purge container 39 are lowered together by the take-up device 14. The split cable 13B inside the purge container 39 is coupled to the coupling link 16 engaging the stopper 26. As a result, the lower end of the split cable 13B suspended in the container body 41 is coupled to the uppermost split cable 13B in the pump column 3.

In step 4-5, the purge container 39, the multiple split cables 13B, and the submersible pump 2 are slightly elevated by the take-up device 14, and the stopper 26 and the support plate 25 are removed from the pump column 3. The load of the submersible pump 2 is supported by the elevating apparatus 12 via the upper lid 43 of the purge container 39.

In step 4-6, the purge container 39, the multiple split cables 13B, and the submersible pump 2 are lowered by the take-up device 14, and the purge container 39 is coupled to the upper portion of the pump column 3. Specifically, as described with reference to FIG. 13, the lower flange 80 of the container body 41 is fixed to the upper flange 3A of the pump column 3 by the bolts 74 and the nuts 75 (see FIG. 13) as the purge-container coupling mechanism. The load of the submersible pump 2 is supported by the upper lid 43 of the purge container 39 via the multiple split cables 13B.

In step 4-7, the purge gas (e.g., including an inert gas and/or a gas composed of the same component as that of the liquefied gas) is supplied through the purge-gas inlet port 47 into the interior space 40 of the container body 41, and the purge gas is exhausted from the interior space 40 through the purge-gas outlet port 48. At the same time, the purge gas flows out through minute gaps other than the purge-gas outlet port 48 of the purge container 39. Such purge gas flow can prevent ambient air from flowing into the interior space 40.

Before or after the supply of the purge gas is started, the cable 13 is disconnected from the upper lid 43. Furthermore, the trunk line 13A of the cable 13 coupled to the take-up device 14 is coupled to the upper end of the split cable 13B inside the container body 41 via the coupling link 16. At this point, the load of the submersible pump 2 is still supported by the upper lid 43 via the multiple split cables 13B.

In step 4-8, the multiple split cables 13B and the submersible pump 2 are elevated by the take-up device 14, and the stopper 67 is removed. The multiple split cables 13B and the submersible pump 2 are elevated until the uppermost one of the multiple split cables 13B is located above the purge container 39.

In step 4-9, the stopper 67 is placed on the upper lid 43 again. The submersible pump 2 and the multiple split cables 13B are lowered by the take-up device 14 until the coupling link 16 just above the stopper 67 engages the stopper 67. When the coupling link 16 engages the stopper 67, the load of the submersible pump 2 is supported by the upper lid 43. One of the multiple split cables 13B that have been the pump column 3 is located inside the container body 41. Since the interior space 40 of the container body 41 is filled with the purge gas, the split cable 13B in the container body 41 does not come into contact with the air and is exposed to the purge gas. As a result, the split cable 13B is warmed by the purge gas. This process is the hot-up operation for the split cable 13B.

In step 4-10, the split cable 13B above the purge container 39 is removed from the cable 13.

In step 4-11, the trunk line 13A of the cable 13 extending from the take-up device 14 is coupled to the coupling link 16 engaging the stopper 67. As a result, the trunk line 13A of the cable 13 is coupled to the submersible pump 2 via the split cables 13B.

Then, the same steps as the steps 4-8 to 4-11 are repeated while removing the multiple split cables 13B one by one, until the submersible pump 2 is elevated to a position near the upper end of the pump column 3.

In step 4-12, the baffle plate 91 is removed from the container body 41. The submersion pump 2 is elevated by the take-up device 14 until the submersion pump 2 is located within the interior space 40 of the container body 41.

In step 4-13, the lower lid 44 is placed on the bottom of the container body 41, and the stopper 67 is placed on the upper lid 43. The load of the submersible pump 2 is supported by the upper lid 43 via the stopper 67 and the pump suspension mechanism 65 including the coupling link 70. The last split cable 13B is then removed. While the upper opening of the container body 41 is covered with the upper lid 43 and the lower opening of the container body 41 is covered with the lower lid 44, the purge gas (including, for example, an inert gas and/or a gas having the same component as that of the liquefied gas) is supplied through the purge-gas inlet port 47 into the interior space 40 of the container body 41 accommodating the submersible pump 2 therein to fill the interior space 40 with the purge gas. The purge gas is exhausted from the interior space 40 through the purge-gas outlet port 48. The purge gas warms up the submersible pump 2 (the hot-up operation). The purge gas may be at room temperature, or may be preheated by a heating device, such as a heater.

In step 4-14, the trunk line 13A of the cable 13 suspended from the take-up device 14 of the elevating apparatus 12 is coupled to the upper lid 43. Further, the bolts 74 and the nuts 75 (see FIG. 13) serving as the purge-container coupling mechanism connecting the container body 41 to the pump column 3 are removed.

In step 4-15, the purge container 39 in which the submersible pump 2 is accommodated is elevated by the elevating apparatus 12 and separated from the pump column 3.

In step 4-16, the purge container 39 in which the submersible pump 2 is accommodated is moved to a location away from the pump column 3 by a transporting device (for example, a crane) not shown.

In step 4-17, the upper lid 43 is removed from the container body 41, and the submersible pump 2 is removed from the purge container 39 by an elevating device (e.g., crane) not shown. At this point, the submersible pump 2 has already been warmed by the purge gas and has a temperature higher than the boiling point of oxygen (−183° C.) and the boiling point of nitrogen (−196° C.). Therefore, even if the air comes into contact with the submersible pump 2, the oxygen and nitrogen in the air are not liquefied.

According to this embodiment, the submersible pump 2 can be warmed with the purge gas (i.e., the hot-up operation), while the ultra-low temperature submersible pump 2 and the split cables 13B are pulled up from the pump column 3 into the purge container 39. This hot-up operation is performed before the submersible pump 2 contacts the atmospheric air. Therefore, components, such as nitrogen, in the air are not liquefied or solidified on the surfaces of the submersible pump 2. In particular, this embodiment is effective when the liquefied gas is liquid hydrogen. Specifically, when the submersible pump 2 that has been immersed in the liquid hydrogen is elevated from the pump column 3, the submersible pump 2 has an ultra-low temperature equivalent to that of liquid hydrogen. The boiling point of hydrogen (−253° C.) is lower than the boiling point of oxygen (−183° C.) and the boiling point of nitrogen (−196° C.). Therefore, when the air comes into contact with the submersible pump 2 immediately after the submersible pump 2 is pulled up from the pump column 3, not only nitrogen in the air but also oxygen is liquefied and may drop into the pump column 3. In this regard, according to the present embodiment, the submersible pump 2 that has been immersed in liquid hydrogen is quickly warmed by the purge gas before the submersible pump 2 contacts the air. Therefore, when the air comes into contact with the submersible pump 2, the oxygen and nitrogen in the air are not liquefied, and the liquefied oxygen and liquefied nitrogen do not drop into the pump column 3. As a result, safe removal of the submersible pump 2 can be achieved.

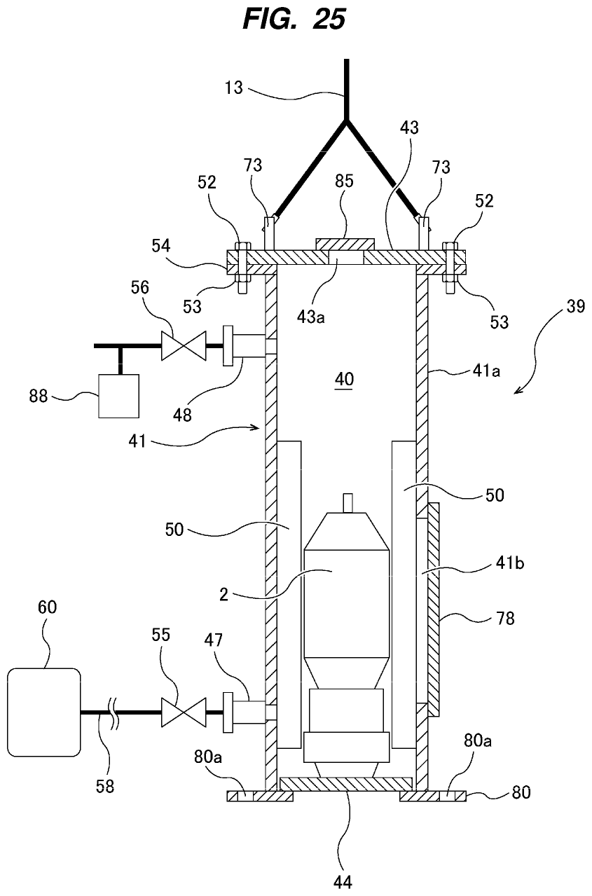

Next, another embodiment of the purge container 39 will be described. FIG. 25 is a cross-sectional view showing another embodiment of the purge container 39. Configurations of this embodiment, which will not be particularly described, are the same as those of the embodiments described with reference to FIGS. 12 and 13, and redundant descriptions thereof will be omitted.

As shown in FIG. 25, the submersible pump 2 is supported by the lower lid 44 of the purge container 39. Specifically, the submersible pump 2 is placed on the lower lid 44 without the pump suspension mechanism 65 shown in FIG. 12. Therefore, the load of the submersible pump 2 is supported by the lower lid 44. The lower lid 44 is configured to be able to support the submersible pump 2. More specifically, the lower lid 44 has sufficiently high mechanical strength to support the load of the submersible pump 2. The center of the upper lid 43 has the hole 43a through which the cable 13 of the elevating apparatus 12 can pass. The hole 43a is closed by a second lid 85. The second lid 85 is removable from the upper lid 43.

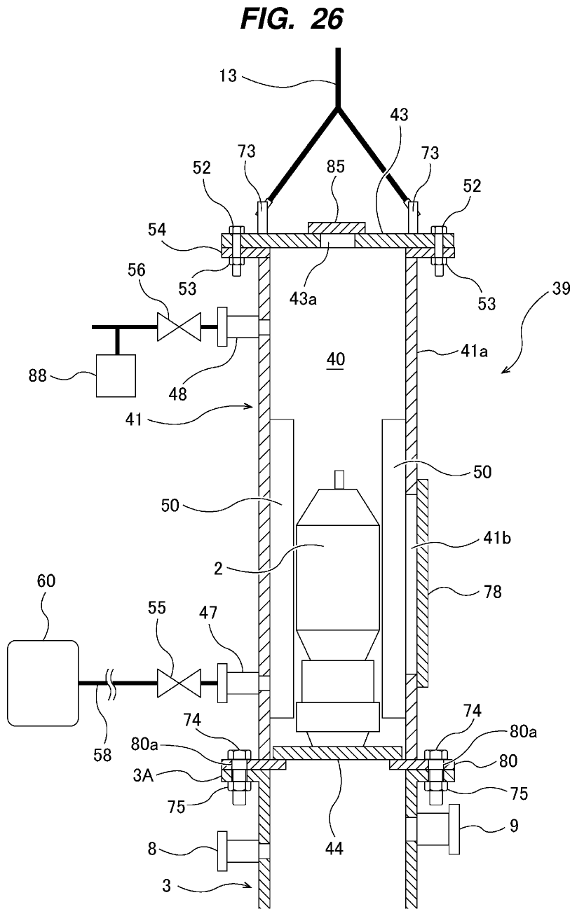

FIG. 26 is a schematic diagram showing the purge container 39 coupled to the upper portion of the pump column 3. As shown in FIG. 26, the purge container 39 with the submersible pump 2 disposed therein is suspended from the cable 13 of the elevating apparatus 12 and is lowered by the elevating apparatus 12 until the lower flange 80 of the container body 41 is brought into contact with the upper flange 3A of the pump column 3. The lower flange 80 of the container body 41 is fixed to the upper flange 3A of the pump column 3 by the bolts 74 and the nuts 75 as the purge-container coupling mechanism. The load of the submersible pump 2 is supported by the lower lid 44 and further supported by the pump column 3 via the lower lid 44.

The embodiment of the dry-up operations for the submersible pump 2 and the split cables 13B described with reference to FIGS. 15 to 19 and the embodiment of the hot-dry operations for the submersible pump 2 and the split cables 13B described with reference to FIGS. 20 to 24 can be applied to the purge container 39 configured to support the submersible pump 2 with the lower lid 44 shown in FIGS. 25 and 26. Specifically, the purge container 39 shown in FIGS. 25 and 26 does not have the pump suspension mechanism 65, but the process of adding the split cables 13B one by one, the process of removing the split cables 13B one by one, the processes of installing the baffle plate 91, the support plate 25, the stopper 26, and the head plate 30 are the same as those in the embodiment described with reference to FIGS. 15 to 24, and therefore their repetitive descriptions are omitted.

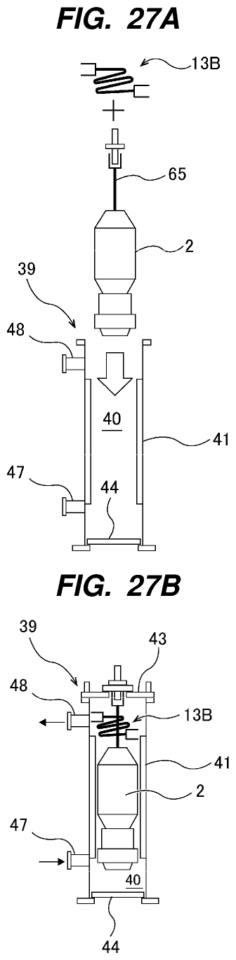

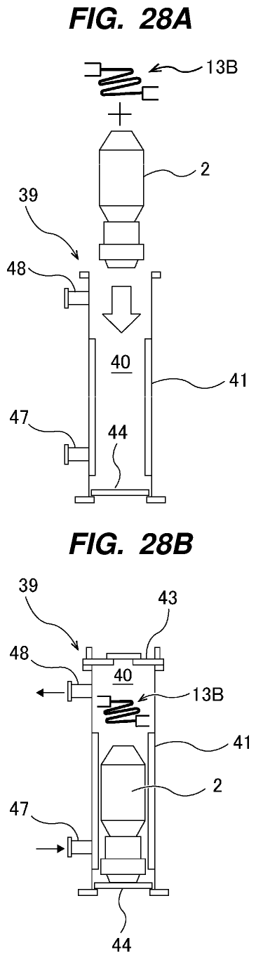

When the submersible pump 2 is dried up, one or more split cables 13B may be dried up at the same time. For example, as shown in FIGS. 27A and 27B, the submersible pump 2 and one or more split cables 13B are accommodated within the container body 41 of the purge container 39 shown in FIG. 12, and the purge gas is supplied into the interior space 40 of the container body 41 to simultaneously expose the submersible pump 2 and the split cable(s) 13B to the purge gas. In another example, as shown in FIGS. 28A and 28B, the submersible pump 2 and one or more split cables 13B are accommodated within the container body 41 of the purge container 39 shown in FIG. 25, and the purge gas is supplied into the interior space 40 of the container body 41 to simultaneously expose the submersible pump 2 and the split cable(s) 13B to the purge gas. These operations can eliminate the dry-up operation for only the one or more split cables 13B when the submersible pump 2 is moved to the pump column 3, thereby reducing the working process and working time.

In each of the above-described embodiments, the suction valve 6 installed in the pump column 3 is configured to be closed by the weight of the submersible pump 2. In another embodiment, the suction valve 6 may be an actuator-driven valve (for example, an electric valve). If the actuator driven valve is used for the suction valve 6, the head plate 30 described above may be omitted.

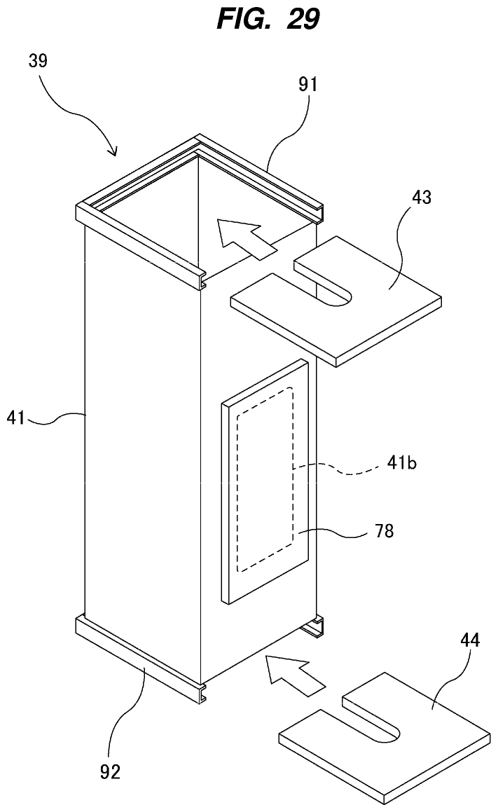

The container body 41 of the purge container 39 is not limited to a cylindrical shape, and may have another shape having a polygonal horizontal cross section. For example, as shown in FIG. 29, the container body 41 may have a rectangular horizontal cross section. Further, as shown in FIG. 29, the upper lid 43 may be configured to be attached to an upper slide rail 91 fixed to the upper end of the container body 41, and the lower lid 44 may be configured to be attached to a lower slide rail 92 fixed to the lower end of the container body 41.

The shape of the opening 41b covered by the side lid 78 is rectangular, but may be other shape, such as a circle or an elongated hole. In an embodiment, a plurality of openings 41b may be provided. The side lid 78 is detachably attached to the container body 41 by screws (not shown). In another embodiment, the side lid 78 may be coupled to the container body 41 by hinges. In still another embodiment, the side lid 78 may be a shutter, slide curtain, or roll curtain.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to an elevating apparatus for elevating and lowering, within a pump column, a submersible pump for pressurizing liquefied gas, such as liquefied ammonia, liquefied natural gas (LNG), or liquid hydrogen. Furthermore, the present invention is applicable to a method of carrying a submersible pump into a pump column and a method of pulling up the submersible pump out of the pump column using such an elevating apparatus.

### REFERENCE SIGNS LIST

2 submersible pump
3 pump column
5 liquefied-gas storage tank
6 suction valve
12 elevating apparatus
13 cable
13A trunk line
13B split cable
14 take-up device
16 coupling link
25 support plate
26 stopper
28 slide rail
30 head plate
31 closing member
32 movable rod
39 purge container
40 interior space
41 container body
43 upper lid
44 lower lid
47 purge-gas inlet port
48 purge-gas outlet port
50 pump guide
52 bolt
53 nut
54 upper flange
55 inlet valve
56 outlet valve
58 purge-gas supply line
60 purge-gas supply source
65 pump suspension mechanism
66 coupling member
67 stopper
70 coupling link
71 suspension cable
73 coupling port
74 bolt
75 nut
78 side lid
80 lower flange
88 purge index measuring device
91 upper slide rail
92 lower slide rail

What is claimed is:

1. An elevating apparatus for elevating and lowering a submersible pump in a pump column, the submersible pump being used to deliver liquefied gas, the elevating apparatus comprising:
a cable including multiple split cables and multiple coupling links configured to detachably couple the multiple split cables to each other; and
a take-up device coupled to the cable.

2. The elevating apparatus according to claim 1, wherein each of the multiple split cables has a length shorter than a height of the pump column in its longitudinal direction.

3. The elevating apparatus according to claim 1, further comprising a stopper having a shape that engages each of the multiple coupling links to prevent at least one of the multiple split cables from falling into the pump column.

4. The elevating apparatus according to claim 3, wherein the stopper is larger than a hole formed in an upper lid covering an upper opening of a purge container coupled to the pump column.

5. The elevating apparatus according to claim 3, further comprising a support plate placed on an upper end of the pump column, the support plate having an opening having a shape that allows the multiple split cables and the multiple coupling links to pass therethrough while the shape does not allow the stopper to pass therethrough.

6. The elevating apparatus according to claim 1, further comprising a head plate placed on an upper end of the pump column,
wherein the head plate has a closing member having a shape that covers an upper opening of the pump column, and a movable rod supported by the closing member,
the movable rod is movable in a vertical direction relative to the closing member, and
the movable rod has a lower end configured to be coupled to one of the multiple split cables.

7. A method of carrying a submersible pump into a pump column, the submersible pump being used to deliver liquefied gas, the method comprising:
coupling a cable to the submersible pump, the cable being coupled to a take-up device, the cable including at least one of multiple split cables that have been prepared in advance; and
lowering the submersible pump in the pump column by the take-up device while adding remainder of the multiple split cables one by one to the cable.

8. The method according to claim 7, wherein the multiple split cables are detachably coupled to each other by multiple coupling links.

9. The method according to claim 7, further comprising:
accommodating the submersible pump in a purge container; and
supplying a purge gas into the purge container to expose the submersible pump to the purge gas.

10. The method according to claim 9, further comprising:
accommodating a newly added split cable in the purge container; and
supplying the purge gas into the purge container to expose the newly added split cable to the purge gas.

11. The method according to claim 9, wherein:
at least one of the multiple split cables and the submersible pump are accommodated in the purge container; and
the purge gas is supplied into the purge container to expose the at least one of the multiple split cables and the submersible pump to the purge gas.

12. The method according to claim 9, wherein the liquefied gas comprises liquid hydrogen, and at least a part of the purge gas comprises a gas composed of a component having a boiling point equal to or lower than a boiling point of hydrogen.

13. The method according to claim 12, wherein the purge gas comprises hydrogen gas.

14. The method according to claim 7, further comprising coupling the multiple split cables located in the pump column to a head plate,
wherein the head plate has a closing member having a shape that covers an upper opening of the pump column, and a movable rod supported by the closing member,
the movable rod is movable in a vertical direction relative to the closing member, and
the movable rod has a lower end coupled to one of the multiple split cables.

15. A method of pulling up a submersible pump out of a pump column, the submersible pump being used to deliver liquefied gas, the method comprising:
coupling a cable to the submersible pump, the cable being coupled to a take-up device, the cable including multiple split cables; and
elevating the submersible pump from the pump column by the take-up device while removing the multiple split cables one by one from the cable.

16. The method according to claim 15, wherein the multiple split cables are detachably coupled to each other by multiple coupling links.

17. The method according to claim 15, further comprising:
before removing one of the multiple split cables, accommodating the one of the multiple split cables in a purge container; and
supplying a purge gas into the purge container to expose the one of the multiple split cables to the purge gas.

18. The method according to claim 17, further comprising:
accommodating the submersible pump in the purge container; and
supplying the purge gas into the purge container to expose the submersible pump to the purge gas.

19. The method according to claim 17, wherein the liquefied gas comprises liquid hydrogen, and at least a part of the purge gas comprises a gas composed of a component having a boiling point equal to or lower than a boiling point of hydrogen.

20. The method according to claim 19, wherein the purge gas comprises hydrogen gas.
